(19) United States
(12) Patent Application Publication
(10) Pub. No.: US 2021/0235268 A1
(43) Pub. Date: Jul. 29, 2021

(54) METHODS AND NODES FOR AUTHENTICATION OF A TLS CONNECTION

(71) Applicant: Telefonaktiebolaget LM Ericsson (publ), Stockholm (SE)

(72) Inventors: Changzheng WU, SHENZHEN (CN); Daniel NILSSON, ÄLVÄNGEN (SE); Jiaqi LIU, SHENZHEN (CN)

(21) Appl. No.: 15/733,812

(22) PCT Filed: Jun. 1, 2018
(86) PCT No.: PCT/CN2018/089505

§ 371 Date: Nov. 30, 2020

(51) Int. Cl. H04W 12/069; H04L 29/06; H04L 9/32

(52) U.S. Cl. CPC H04W 12/069; H04L 63/0823; H04L 9/3242; H04L 63/166

(57) ABSTRACT

The embodiments herein relate to a method performed by an access GW node of a non-3GPP access for authentication of a TLS connection. The access GW node receives a 2^{nd} key derived during an authentication procedure. The access GW node receives a first TLS message comprising first authentication data and calculates second authentication data based on a 1^{st} key and the 2^{nd} key. The 1^{st} key is associated with the TLS connection. The access GW node calculates third authentication data based on the 1^{st} and 2^{nd} keys. The access GW node transmits the second TLS message comprising the third authentication data. The access GW node verifies that the first authentication data is substantially the same as the second authentication data, and authenticates the TLS connection when the received first authentication data is successfully verified.

### TECHNICAL FIELD

Embodiments herein relate generally to an access gateway (GW) node, a method performed by the access GW node, a communication device and a method performed by the communication device. More particularly the embodiments herein relate to authentication of a Transport Layer Security (TLS) connection.

### BACKGROUND

According to the third Generation Partnership Project (3GPP) Technical Specification (TS) 23.501 V0.3.1 (2017 March), “The 5G System architecture is defined to support data connectivity and services enabling deployments to use techniques such as e.g. Network Function Virtualization and Software Defined Networking. The 5G System architecture shall leverage service-based interactions between Control Plane (CP) Network Functions where identified”. Some key concept in Fifth Generation (5G) telecommunications is that the User Plane (UP) functions are separated from the CP functions, that the function design is modularized etc.

The 5G system architecture comprises different Network Functions (NF). Below is a list of some of these NFs:
Authentication Server Function (AUSF)
Access and Mobility Management Function (AMF)
Data network (DN), e.g. operator services, Internet access or 3rd party services
Structured Data Storage network function (SDSF)
Unstructured Data Storage network function (UDSF)
Network Exposure Function (NEF)
NF Repository Function (NRF)
Policy Control function (PCF)
Session Management Function (SMF)
Unified Data Management (UDM)
User plane Function (UPF)
Application Function (AF)
User Equipment (UE)
(Radio) Access Network ((R)AN)

The above listed functions will be described in more detail below with reference to FIG. 1.

In the 5G work in the 3GPP it has been agreed to do a further split between Mobility Management (MM) and Session Management (SM) compared to in the Evolved Packet Core (EPC), i.e. the fourth generation (4G), where the Mobility Management Entity (MME) supports both MM and some SM functionality. In 5G, the AMF supports the MM functionality and the SMF supports SM functionality. The SMF has an interface to the UPF and is in charge of controlling the UPF, e.g. instructing the UPF on tunnel endpoints, enforcements rules for maximum bitrate, charging control rules etc.

FIG. 1 illustrates an exemplary non-roaming reference architecture for a 5G system. In general, a 5G system comprises a 5G Access Network (AN), a 5G Core Network (CN) and UE. Service-based interfaces are used within the Control Plane in FIG. 1. In a service-based representation, network functions, e.g. AMF, within the Control Plane enables other authorized network functions to access their services. In more detail, FIG. 1 illustrates a UE 101a that is adapted to be connected to a (Radio) Access Network ((R)AN) 103a. The (R)AN 103a is adapted to be connected to an Access and Mobility Management Function (AMF) 105 via a N2 reference point. The UE 101a is adapted to be connected to the AMF 105 via a N1 reference point. The (R)AN 103a is adapted to be connected to a UPF 125 via a N3 reference point. The UPF 125 is adapted to be connected to a SMF 108 via a N4 reference point. The UPF 125 is adapted to be connected to a Data Network (DN) 120 via a N6 reference point. The DN 120 may be e.g. operator services, Internet access or 3rd party services. A reference point may also be referred to as an interface. FIG. 1 further illustrates an AUSF 128.

The control plane in FIG. 1 illustrates the following service-based interfaces
Namf: Service-based interface exhibited by AMF 105.
Nsmf: Service-based interface exhibited by SMF 108.
Nnef: Service-based interface exhibited by NEF 131.
Npcf: Service-based interface exhibited by PCF 133.
Nudm: Service-based interface exhibited by UDM 130.
Naf: Service-based interface exhibited by AF 135.
Nnrf: Service-based interface exhibited by NRF 132.
Nnssf: Service-based interface exhibited by NSSF 129.
Nausf: Service-based interface exhibited by AUSF 128.

The UE 101a may be a device by which a subscriber may access services offered by an operator's network and services outside operator's network to which the operators radio access network and core network provide access, e.g. access to the Internet. The UE 101a may be any device, mobile or stationary, enabled to communicate in the communications network, for instance but not limited to e.g. user equipment, mobile phone, smart phone, sensors, meters, vehicles, household appliances, medical appliances, media players, cameras, Machine to Machine (M2M) device, Device to Device (D2D) device, Internet of Things (IoT) device, terminal device, communication device or any type of consumer electronic, for instance but not limited to television, radio, lighting arrangements, tablet computer, laptop or Personal Computer (PC). The UE 101a may be portable, pocket storable, hand held, computer comprised, or vehicle mounted devices, enabled to communicate voice and/or data, via the radio access network, with another entity, such as another UE or a server. 3GPP TR 21.905 V14.1.1 (2017 June) defines the UE 101a as follows: “Allows a user access to network services. For the purpose of 3GPP specifications the interface between the UE and the network is the radio interface. A User Equipment can be subdivided into a number of domains, the domains being separated by reference points. Currently the User Equipment is subdivided into the UICC domain and the ME Domain. The ME Domain can further be subdivided into one or more Mobile Termination (MT) and Terminal Equipment (TE) components showing the connectivity between multiple functional groups.”

The (R)AN 103a may comprise a RAN node (not shown in FIG. 1) such as a base station, a NodeB, an evolved NodeB (eNodeB), gNB, Next Generation-RAN (NG-RAN), a Non-3GPP Interworking Function (N3IWF), a Trusted Non-3GPP Gateway Function (TNGF) or any other network unit capable to communicate over a radio carrier with the UE 101a. In general, N3IWF is for non-3GPP access, e.g. trusted or untrusted. The abbreviations (R)AN and RAN may be used interchangeably herein when referring to an Access Network (AN), a radio access network, a node comprised in the access network and a node comprised in the radio access network. The reference number 103a may also be when referring to the (R)AN and RAN and the RAN node. The (R)AN 103a may include both a 3GPP radio access network and a non-3GPP access network. A typical non-3GPP access network is a Wi-Fi network or fixed access network.

It should be noted that the communication links in the system illustrated in FIG. 1 may be of any suitable kind including either a wired or wireless link. The link may use any suitable protocol depending on type and level of layer, e.g. as indicated by the Open Systems Interconnection (OSI) model, as understood by the person skilled in the art.

As mentioned above, the R(AN) 103a can be any type of access node and in release 15 of the 3GPP standard, the defined nodes are gNB (for 3GPP access) and N3IWF (for untrusted non-3GPP access). A general concept for 5G Core (5GC) is according to 3GPP TS23.501, V15.1.0, section 4.1: “Minimize dependencies between the Access Network (AN) and the Core Network (CN). The architecture is defined with a converged core network with a common AN-CN interface which integrates different Access Types e.g. 3GPP access and non-3GPP access.”. This means that the reference points between the UE 103a and the AMF 105 and between the UE 103a and the R(AN) 103a should be access agnostic so that adding support for new accesses should not impact these reference points.

An access network may be of different types. For example, an access network may be wireless or fixed, it may be a 3GPP radio access network or a non-3GPP access network, and it may be a trusted or untrusted access network. Non-3GPP access includes access from for instance MulteFire, Wi-Fi, WiMAX, fixed and CDMA networks. Below are some examples of access network types:
Fixed access.
Untrusted non-3GPP access.
Trusted non-3GPP access.

The 3GPP and the BroadBand Forum (BBF) are currently performing studies to add support for fixed access in 5GC. FIG. 2 shows the general architecture for such fixed access. The architecture in FIG. 2 differs from that of FIG. 1 mainly by the UE 101a is replaced by a Residential Gateway (RG) 101b and the (R)AN node 103a is replaced by an Access Gateway Function (AGF) 103b. The RG 101b may use fixed access, such as cable, fiber or xDSL, to connect to the fixed access network. The RG 101b may have layer two, i.e. Ethernet, or layer three connectivity with the AGF 103b. The layer two or three connectivity may be used for signaling and sending data payload between the RG 101b and the 5GC via the AGF 103b. The reference point between the RG 101b and the AGF 103b may be referred to as an UF reference point. See the description of FIG. 1 for details regarding the other functions shown in FIG. 2.

The RG 101b may be a 5G RG which is defined in 3GPP TS 23.716 as “A 5G-RG is a RG capable of connecting to 5GC playing the role of a UE with regard to the 5G core. It supports secure element and exchanges N1 signalling with 5GC”.

Before a RG 101b may use the services of the 5GC, the RG 101b has to register to the network. This procedure is described in TS 23.502 version 15.1.0 for 3GPP access and untrusted non-3GPP access. The registration procedure may be similar for fixed access and the RG 101b may need to authenticate itself to the 5GC network using SIM credentials or e.g. a PKI certificate. However, the registration procedure requires a transport protocol between the RG 101b and the AGF 103b.

TLS protocol is a protocol for providing communications security over the Internet. In general, the TLS protocol allows client and server applications to communicate while eavesdropping, tampering, or message forgery is prevented. TLS is described in RFC 5246. TLS can be used to setup a secure connection and both the client (e.g. the RG 101b) and the server (e.g. the AGF 103b) can be authenticated using TLS techniques directly, but the 5GC relies on its own authentication mechanism which is performed during the 5GC registration procedure. It is possible to skip the client/RG 101b authentication during the TLS connection setup and then do the 5GC registration/authentication over the TLS connection, but once the RG 101b is authenticated there is a need to also authenticate the TLS connection to make sure there is no man-in-the-middle attack. There is no described solution for how to connect the authentication in the 5GC registration procedure with the TLS connection to secure the transport protocol. The TLS connection will also be used after 5GC registration procedure why it is important to verify that the connection is secure. One alternative could be to use client authentication on both TLS and NAS layer but two layers of authentication are very cumbersome, especially the certificate based authentication by TLS.

Therefore, there is a need to at least mitigate or solve these issues.

### SUMMARY

An objective of embodiments herein is therefore to obviate at least one of the above disadvantages and to provide improved authentication of a TLS connection.

According to a first aspect, the object is achieved by a method performed by an access GW node of a non-3GPP access for authentication of a TLS connection between the access GW node and a communication device. The access GW node receives, from a CN function, a 2^{nd} key derived during an authentication procedure of the communication device 101. The access GW node receives a first TLS message comprising first authentication data from the communication device. The access GW node calculates second authentication data based on a 1st key and the 2^{nd} key and for the received first TLS message. The 1st key is associated with the TLS connection. The access GW node calculates third authentication data based on the 1st and 2^{nd} keys and for a second TLS message to be transmitted. The access GW node transmits the second TLS message comprising the third authentication data to the communication device. The access GW node verifies that the received first authentication data is substantially the same as the calculated second authentication data. The access GW node authenticates the TLS connection when the received first authentication data is successfully verified.

According to a second aspect, the object is achieved by a method performed by a communication device of a non-3GPP access for authentication of a TLS connection between an access GW node and the communication device. The communication device generates, a 2^{nd} key derived during an authentication procedure of the communication device. The communication device calculates first authentication data based on a 1^{st} key and the 2^{nd} key and for a TLS message to be transmitted. The 1^{st} key is associated with the TLS connection. The communication device transmits a first TLS message comprising first authentication data to the access GW node. The communication device receives a second TLS message comprising third authentication data from the access GW node. The communication node calculates fourth authentication data based on the 1^{st} and 2^{nd} keys. The communication node verifies that the received third authentication data is substantially the same as the calculated fourth authentication data, and authenticates the TLS connection when the received third authentication data is successfully verified

According to a third aspect, the object is achieved by an access GW node of a non-3GPP access. The access GW node is configured to receive, from a CN function, a 2^{nd} key derived during an authentication procedure of a communication device. The access GW node is configured to receive a first TLS message comprising first authentication data from the communication device. The access GW node is configured to calculate second authentication data based on a 1^{st} key and the 2^{nd} key and for the received first TLS message. The 1^{st} key is associated with a TLS connection between the access GW node and the communication device. The access GW node is configured to calculate third authentication data based on the 1^{st} and 2^{nd} keys and for a second TLS message to be transmitted. The access GW node is configured to transmit the second TLS message comprising the third authentication data to the communication device. The access GW node is configured to verify that the received first authentication data is substantially the same as the calculated second authentication data, and to authenticate the TLS connection between the access GW node and a communication device when the received first authentication data is successfully verified.

According to a fourth aspect, the object is achieved by a communication device of a non-3GPP access. The communication device is configured to generate a 2^{nd} key derived during an authentication procedure of the communication device. The communication device is configured to calculate first authentication data based on a 1^{st} key and the 2^{nd} key and for a TLS message to be transmitted. The 1^{st} key is associated with a TLS connection between an access GW node and the communication device. The communication device is configured to transmit a first TLS message comprising first authentication data to the access GW node. The communication device is configured to receive a second TLS message comprising third authentication data from the access GW node. The communication device is configured to calculate fourth authentication data based on the 1^{st} and 2^{nd} keys. The communication device is configured to verify that the received third authentication data is substantially the same as the calculated fourth authentication data, and to authenticate the TLS connection between the access GW node and the communication device when the received third authentication data is successfully verified.

Embodiments herein afford many advantages, of which a non-exhaustive list of examples follows:

One advantage of the embodiments herein is that they provide a TLS method to support 5G non-3GPP AN.

Another advantage of the embodiments herein is that they provide a secure connection for a communication device to connect to the 5G core from a trusted or untrusted non-3GPP AN.

A further advantage of the embodiments herein is that they eliminate the need to install a certificate on each communication device, while leveraging the higher layer (e.g. NAS) authentication to attain the same level of authenticity.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail in the following detailed description by reference to the appended drawings illustrating the embodiments and in which:

FIG. 1 is a schematic block diagram illustrating an example of a 5G system;

FIG. 2 is a schematic block diagram illustrating an example of a 5G system supporting fixed access.

FIG. 3 is a schematic block diagram illustrating an example of a 5G system.

FIG. 4 is a signaling diagram illustrating embodiments of a method.

FIG. 5a-5b are signaling diagrams illustrating embodiments of a method.

FIG. 6a-6b are signaling diagrams illustrating embodiments of a method.

FIG. 7a-7b are signaling diagrams illustrating embodiments of a method.

FIG. 8a-8b are signaling diagrams illustrating embodiments of a method.

FIG. 9 is a flow chart illustrating embodiments of a method performed by a communication device.

FIG. 10 is a flow chart illustrating embodiments of a method performed by an access GW node.

FIG. 11 is a schematic block diagram illustrating embodiments of a communication device.

FIG. 12 is a schematic block diagram illustrating embodiments of an access GW node.

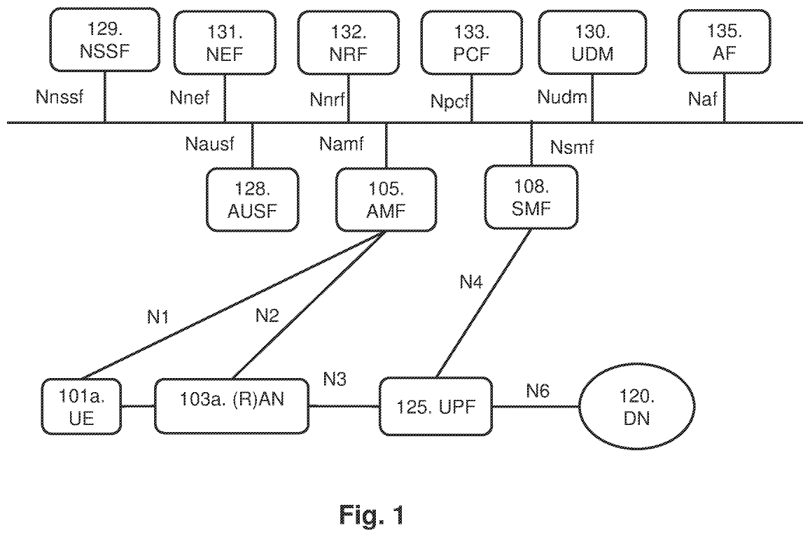

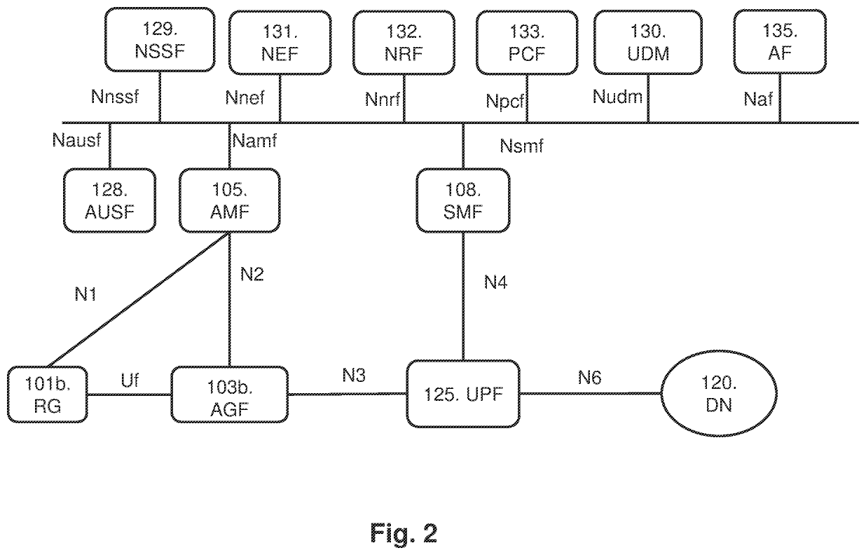

The drawings are not necessarily to scale and the dimensions of certain features may have been exaggerated for the sake of clarity. Emphasis is instead placed upon illustrating the principle of the embodiments herein.

### DETAILED DESCRIPTION

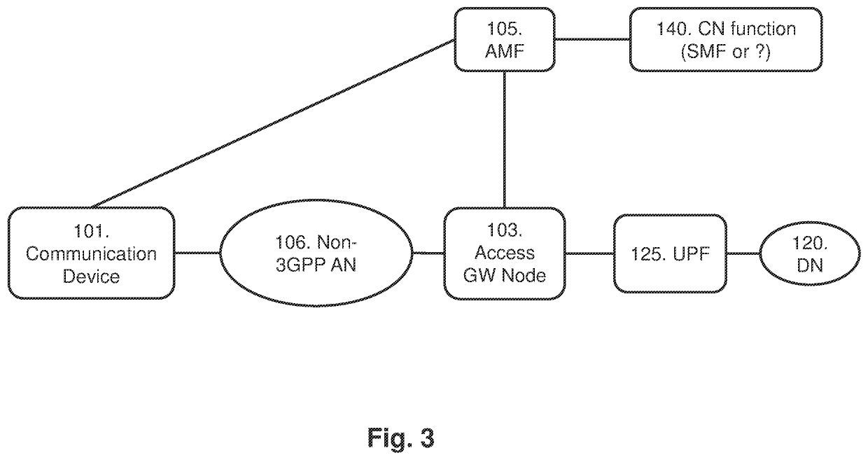

FIG. 3 depicts an example of a communications system in which the embodiments herein may be implemented. The system comprises a communication device 101. The communication device 101 may be a UE 101a, a Customer Premises Equipment (CPE), a 5G UE communication device a 5G capable communication device, a 5G compatible communication device, a Next Generation (NextGen) communication device, a RG, a 5G-RG etc. The reference number 101 is used herein when referring to any of the communication device examples listed above.

The communication device 101 is adapted to be connected to a non-3GPP AN 106. The non-3GPP AN 106 may be one of the following:
Fixed access.
Untrusted non-3GPP access,
Trusted non-3GPP access.

The non-3GPP AN 106 comprises an access gateway (GW) node 103. The access GW node 103 may be an AGF or a FAGF 103a for a fixed AN or a RAN node 103b, N3IWF or TNGF for a trusted/untrutsted non-3GPP AN 106.

The communication device 101 may also be referred to as a client device and the access GW node 103 may be referred to as a server device.

The communication device 103 and the access GW node 103 may both be adapted to be connected to an AMF 105. The AMF 105 may be adapted to be connected to a CN function 140. The CN function 140 may be for example a SMF 108, an UPF 125 etc.

Table 1 below shows some examples of the different entities in the communication system in FIG. 3:

TABLE 1

| Non-3GPP AN | Communication | Access GW node | CN function |
|---|---|---|---|
| 106 | device 101 | 103 | 140 |
| Untrusted non- | UE 101a | RAN node 103a or | SMF 108 or |
| 3GPP access | | N3IWF | UPF 125 |
| Trusted non- | UE 101a | AN node 103a, | SMF 108 or |
| 3GPP access | | N3IWF, or TNGF | UPF 125 |
| Fixed access | CPE or RG | AGF 103b or FAGF | SMF 108 or |
| | | | UPF 125 |

It should be noted that the communication links in FIG. 3 may be of any suitable kind including either a wired or wireless link. The link may use any suitable protocol depending on type and level of layer (e.g. as indicated by the OSI model) as understood by the person skilled in the art.

Even though FIG. 3 uses the term function for at least one of the illustrated units, the term node may be equally applied. In this case, the illustrated units may be referred to as UP node, SM node, and other network node.

Embodiments herein may be implemented to provide a secure link to a communication system as the one exemplified in FIG. 3 by providing TLS tunnel authentication for a non-3GPP TLS tunnel (N3TT) established between an access GW node 103 and a communication device 101 in form of a UE 101a or RG 101b (not shown in FIG. 3). The entities illustrated in FIG. 3 may be nodes, units, modules, functions etc.

In addition, there may be other network functions such as e.g. one or more PCFs. Network Function is defined by the 3GPP as “A 3GPP adopted or 3GPP defined processing function in a network, which has defined functional behavior and 3GPP defined interfaces. A network function can be implemented either as a network element on a dedicated hardware, as a software instance running on a dedicated hardware, or as a virtualized function instantiated on an appropriate platform, e.g. on a cloud infrastructure.”

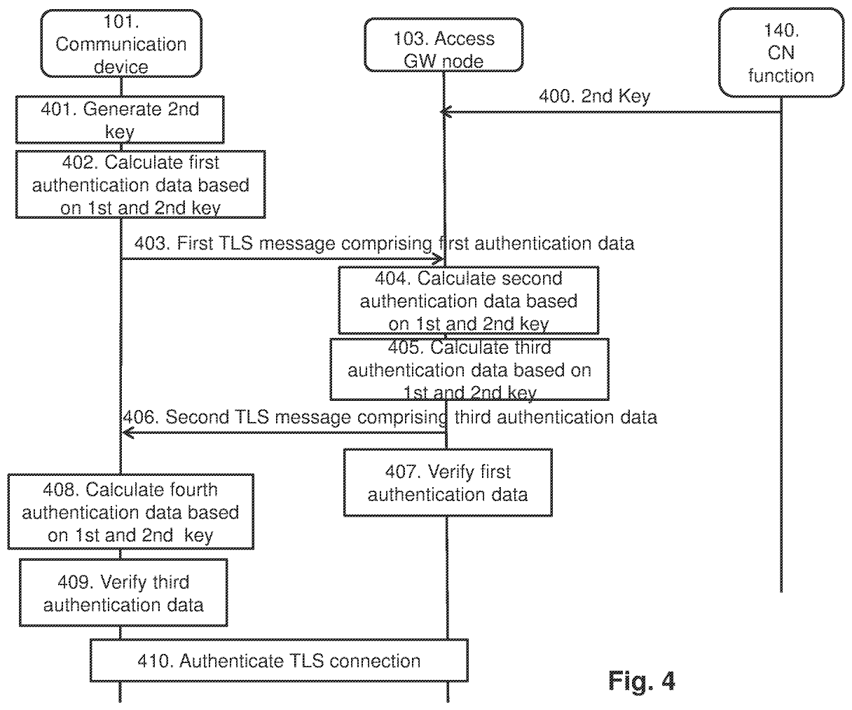

One example method of non-3GPP access for authentication of a TLS connection, between the access node 103 and a communication device 101 will now be described with reference to FIG. 4. Before step 400 is performed, the TLS connection is established, and the establishment is associated with a first (1^{st}) key. The 1^{st} key may for example be based on TLS secret. Both the communication device 101 and the access GW node 103 generate the 1^{st} key when the ongoing TLS connection is setup. FIG. 4 comprises at least one of the following steps, which steps may be performed in any suitable order than described below:

Step 400

During an authentication procedure of the communication device 101, the communication device 101 generates a second (2^{nd}) key. The 2^{nd} key may be a 2^{nd} authentication key, a 2^{nd} security key, etc. The 2^{nd} key comprises any suitable number of numbers or characters. The communication device 101 may generate the 2^{nd} key upon request from another entity in the system, it may generate they 2^{nd} key upon attach to the non-3GPP AN 106, it may generate they 2^{nd} key on a regular basis etc.

Step 401

The CN function 140 generates the 2^{nd} key and sends it to the access GW node 103. The 2^{nd} key may be a 2^{nd} authentication key, a 2^{nd} security key, etc. The access GW node 103 receives the 2^{nd} key from the CN function 140. The CN function 140 may generate the 2^{nd} key upon request from the access GW node 103 or from another node in the system, it may generate the 2^{nd} key upon attach to the non-3GPP AN 106, it may generate the 2^{nd} key on a regular basis etc. The 2^{nd} key generated by the CN function 140 in step 401 is the same as the 2^{nd} key generated by the communication device 101 in step 400.

Steps 400 may be performed before step 401, step 401 may be performed before step 400 or steps 400 and 401 may be performed at the same time.

Step 402

The communication device 101 calculates first authentication data based on the 1^{st} key and the 2^{nd} key from step 400. In more detail, the first authentication data is calculated based on the 1^{st} key from the ongoing TLS connection and based on the 2^{nd} key from the NAS user level authentication. The first authentication data may comprise a first Hash parameter or a first Authentication (Auth) parameter. The first authentication data is for a TLS message to be transmitted to the access GW node 103.

The 1^{st} and 2^{nd} keys are different keys, generated at different occasions and based on different input. The communication device 101 and the access GW node 103 may need to prove they have both these two keys and this may be done by calculating the authentication data based on both these keys.

Step 403

The communication device 101 transmits a first TLS message comprising the first authentication data to the access GW node 103. The access GW node 103 receives the first TLS message from the communication device 101.

Step 404

The access GW node 103 calculates second authentication data based on the 1^{st} key and the 2^{nd} key from step 401 and for the received first TLS message.

Step 405

The access GW node 103 calculates third authentication data based on the 1^{st} and 2^{nd} keys and for a second TLS message to be transmitted.

Step 406

The access GW node 103 sends a second TLS message comprising third authentication data to the communication device 101. The communication device 101 receives the second TLS message from the access GW node 103.

Steps 405 and 406 may be performed before or after step 407.

Step 407

The access GW node 103 verifies that the received first authentication data is substantially the same as the calculated second authentication data. The verification may be performed by comparing the first authentication data with the second authentication data. If the data are substantially the same, then they are successfully verified. If the data are not substantially the same, then they are not verified.

Step 408

The communication node 101 calculates fourth authentication data based on the 1^{st} and 2^{nd} keys.

Step 409

The communication node 101 verifies that the received third authentication data is substantially the same as the calculated fourth authentication data. The verification may be performed by comparing the third authentication data with the fourth authentication data. If the data are substantially the same, then they are successfully verified. If the data are not substantially the same, then they are not verified.

Steps 406, 408 and 409 may be performed before or after steps 402-404.

Step 410

When the communication node 101 and the access GW node 103 both have successfully verified the authentication data in steps 407 and 409, then the TLS connection is authenticated. Note that the TLS connection may also be referred to as a N3TT connection

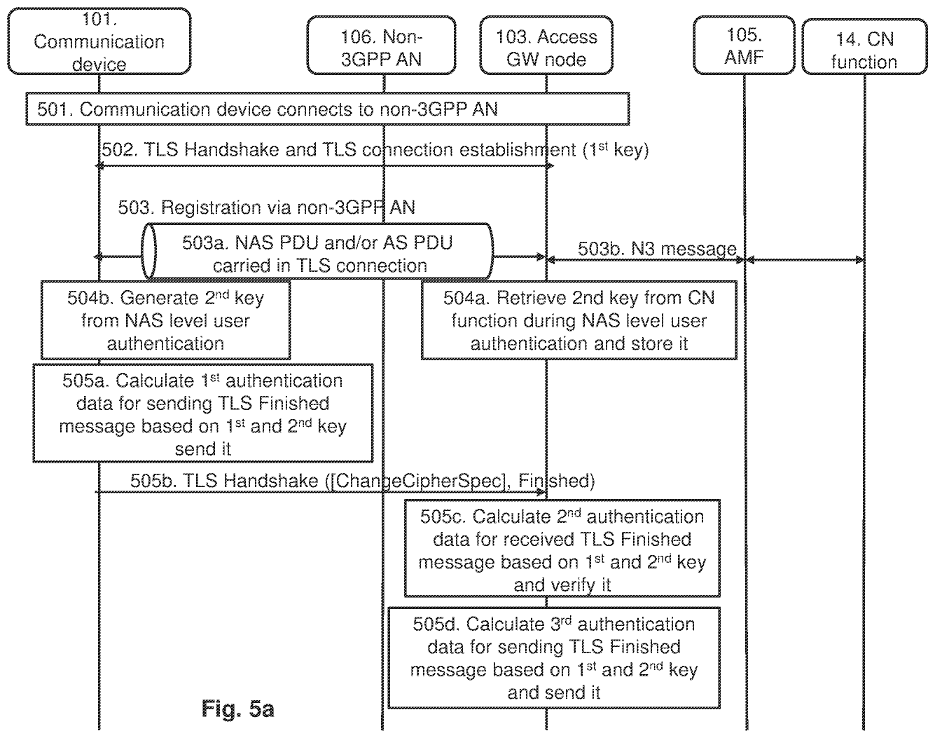

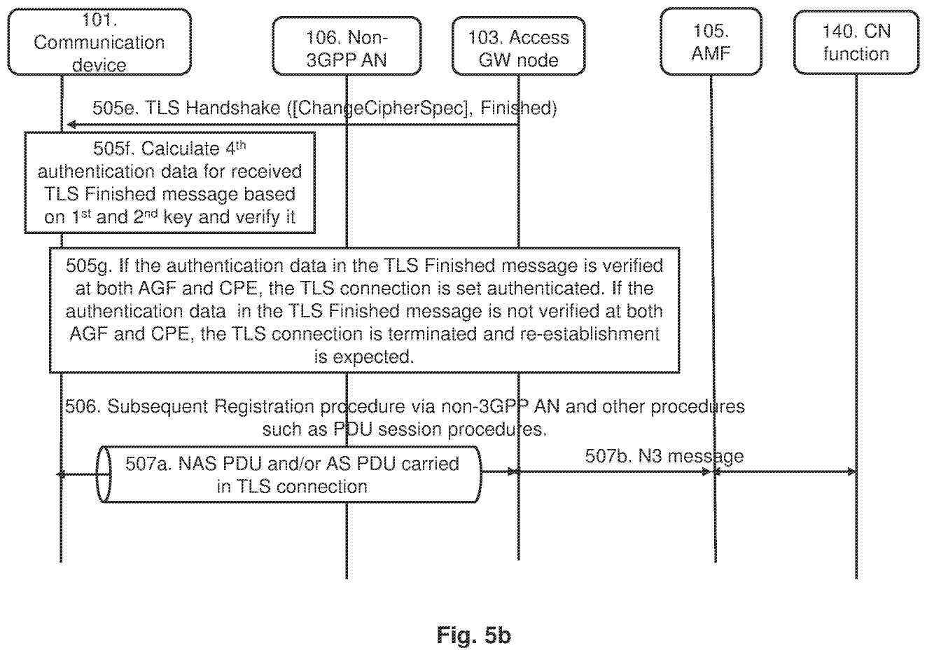

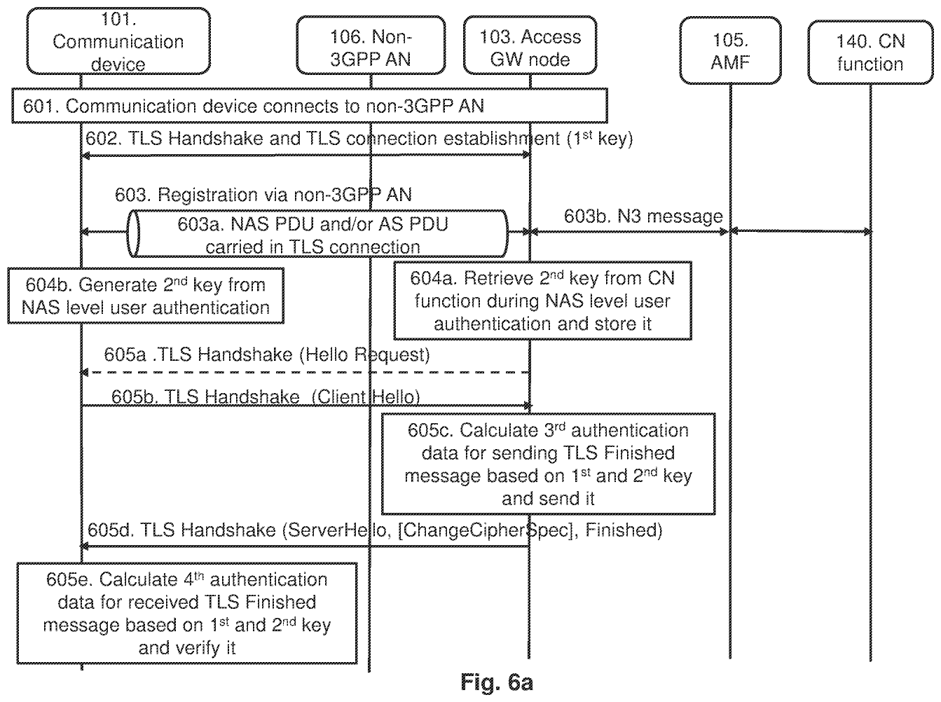

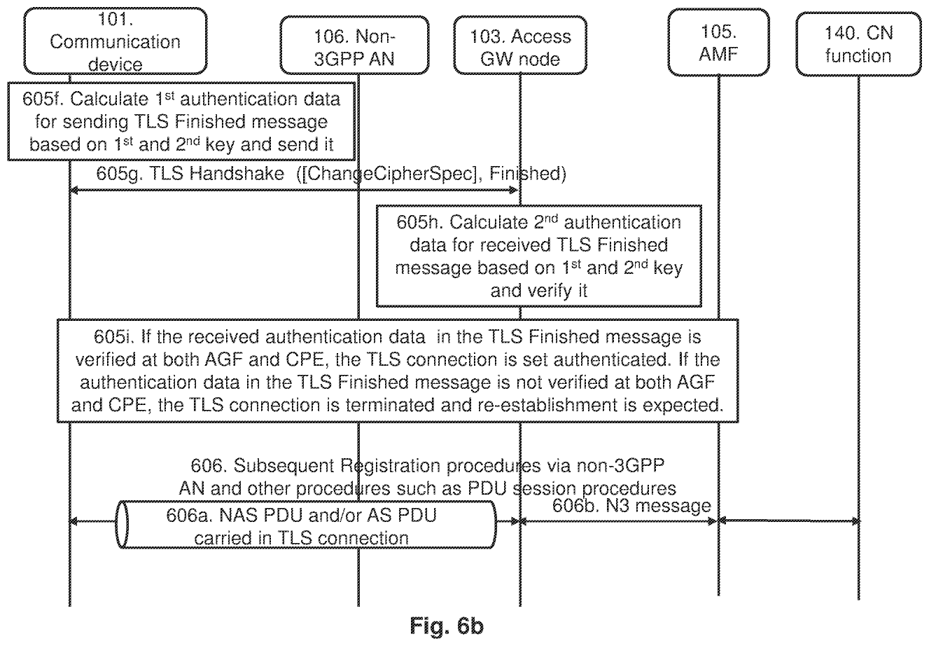

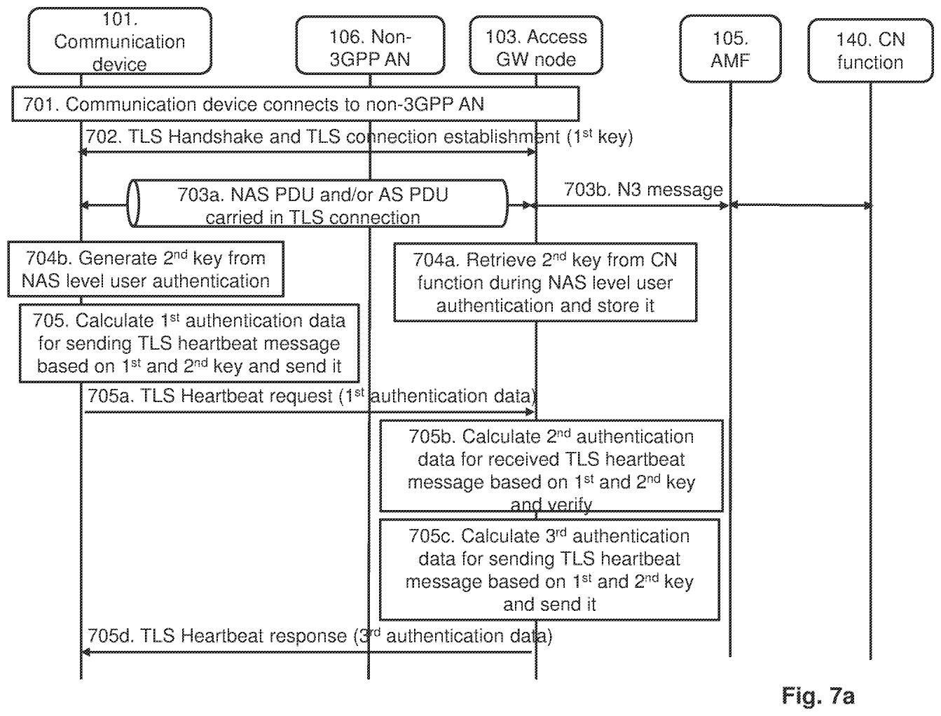

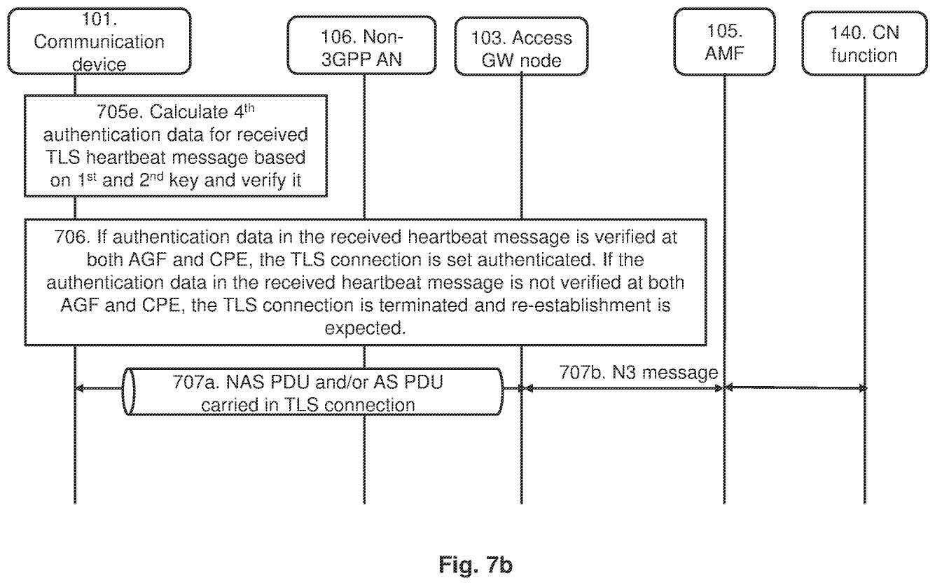

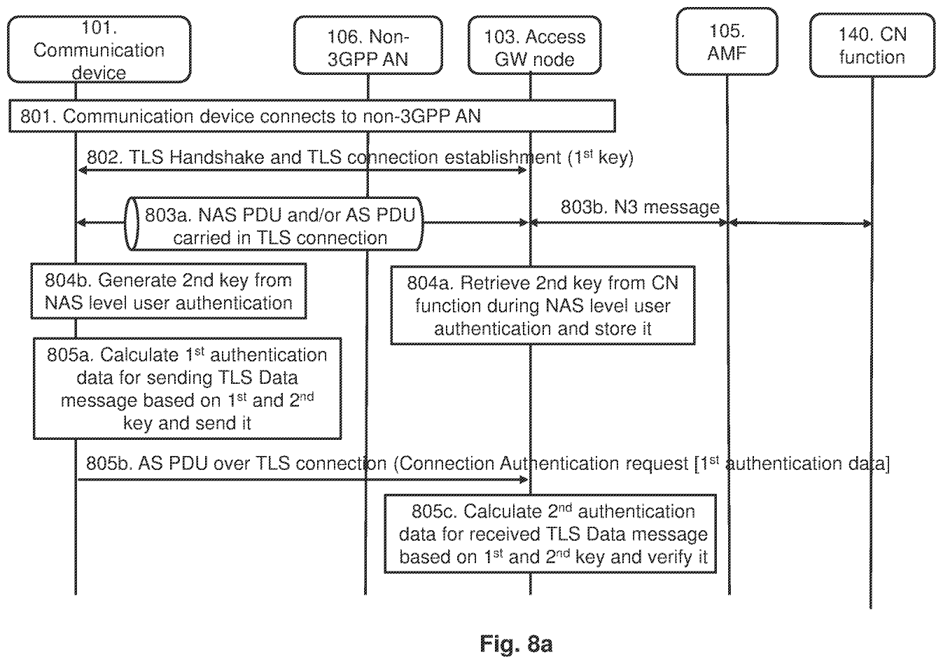

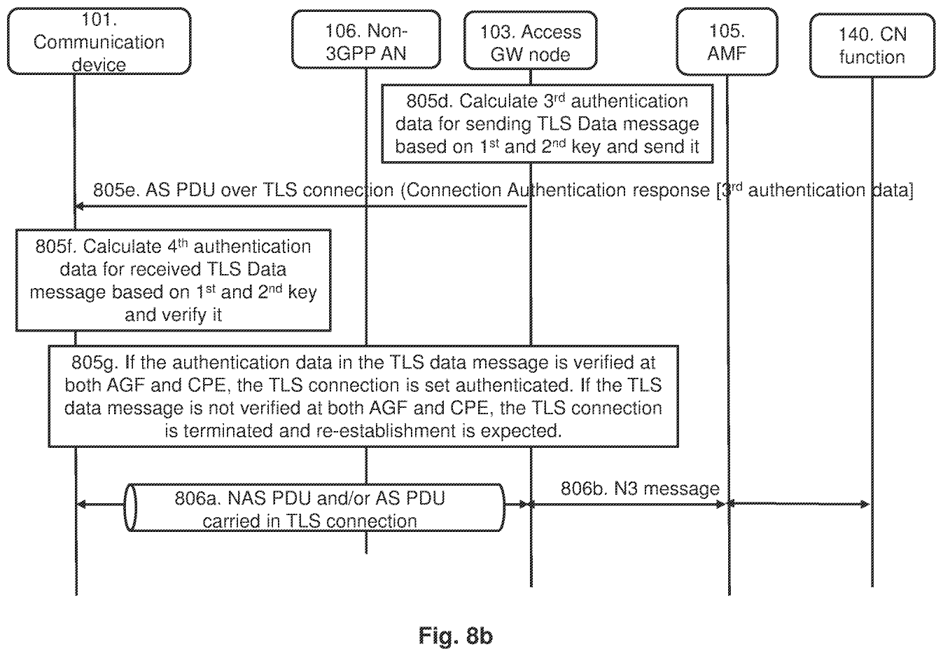

There are at least the following alternative embodiments for authentication of the TLS connection:
Alternative 1: TLS finished message based connection authentication method, see FIGS. 5a and 5b.
Alternative 2: TLS session resume based connection authentication method, see FIGS. 6a and 6b.
Alternative 3: TLS heartbeat based connection authentication method, see FIGS. 7a and 7b.
Alternative 4: TLS inline message based connection authentication method, see FIGS. 8a and 8b.

For all alternatives above similar pre-authentication of the TLS connection setup and connection authentication negotiation may be used, which is described below.

The communication device 101 requests an establishment procedure to establish a TLS connection between the communication device 101 and the access GW node 103.

In order to establish a TLS connection, the communication device 101 shall attach to non-3GPP AN 106 and obtain configuration data such as an IP address.

When IP connectivity is established, the communication device 101 shall establish a TLS connection over IP.

In the pre-authentication TLS connection setup, the access GW node 103 will provide an access GW node certificate and authenticate to the communication device 101. The communication device 101 will not authenticate to the access GW node 103 and will also not provide a client certificate, which is already supported by TLS. The authentication of the communication device 101 will be deferred to NAS basing 5G registration phase under 3GPP credentials.

In the pre-authentication TLS connection setup, both the communication device 101 and the access GW node 103 will negotiate tunnel authentication modes as described below by using e.g. TLS hello extension. The procedures for each tunnel authentication method are exemplified in FIGS. 5-8 described below.

When a TLS message such as e.g. a TLS finished message, is sent, the communication device 10 and the access GW node 103 shall use the TLS connection for transport of signaling traffic in general. The communication device 101 is expected to do the 5G registration which will include the authentication of the client. If the established TLS connection is not verified, the access GW node 103 may terminate the TLS connection unless connection authentication procedures (as specified below) can be successfully completed within a given time.

The alternatives 1-4 briefly mentioned above will now be described in more detail, i.e. the TLS connection setup with TLS connection authentication.

Alternative 1—TLS Finished Message Based Connection Authentication

The method for TLS connection authentication according to alternative 1 will now be described with reference to the signaling diagram in FIGS. 5a and 5b. FIG. 5b is a continuation of FIG. 5a such that the method steps in FIG. 5a are performed before the method steps in FIG. 5b.

FIG. 5a and FIG. 5b are signaling diagrams illustrating an embodiment of a method for TLS connection authentication, based on TLS Finished message. The method comprises at least one of the following steps, which steps may be performed in any suitable order than described below:

Step 501

This step is shown in FIG. 5a. The communication device 101 will attach to the non-3GPP AN 106 and gets configuration such as the IP address configuration.

Step 502

This step is shown in FIG. 5a. In step 502, the communication device 101 performs a TLS handshake with the access GW node 103 to establish the TLS connection. During the handshake, the access GW node authentication is usually required and the access GW node certificate may be provided to the communication device 101. The communication device authentication is not required and it is not required to provide the communication device certificate to the access GW node 103. Communication device authentication will be deferred to NAS registration phase. TLS connection authentication mode for communication device authentication is negotiated using a TLS hello extension. In this alternative 1, direct_tauth_mode is negotiated. Note that negotiation of connection authentication method is optional.

The following extension may be added into hello extension to negotiate tunnel authentication mode:

enum {
direct _tauth_mode(1),
resume_tauth_mode(2),
heartbeat_tauth_mode(3),
inline_tauth_mode(4),
(255)
} TunnelAuthMode;
struct {
TunnelAuthMode mode;
} TunnelAuthModeExtension;

A 1^{st} key is used during the TLS connection establishment in step 502. The 1^{st} key may be referred to as a 1^{st} authentication key, a 1^{st} security key etc. The 1^{st} key may be based on a TLS_secret parameter, which will be described in more detail later. Both the communication device 101 and the access GW node 103 generate the 1^{st} key when the ongoing TLS connection is setup. The 1^{st} and 2^{nd} keys are different keys, generated at different occasions and based on different input. The communication device 101 and the access GW node 103 may need to prove they have both these two keys and this may be done by calculating the authentication data based on both these keys.

Step 503

Registration via non-3GPP AN is performed, and this is done with steps 503a and 503b described below.

Step 503a

This step is shown in FIG. 5a. After the TLS connection has been pre-established since one-way authentication is done only without communication device authenticated, at least one of the NAS PDU and/or the AS PDU is transferred from the communication device 101, via the TLS connection, to the access GW node 103 for 5G registration and communication device authentication using 3GPP credential.

Step 503b

This step is shown in FIG. 5a. The access GW node 103 may send at least one N3 message to the CN function 140, e.g. via the AMF 105. The N3 message may comprise the NAS PDU.

Step 504a

This step is shown in FIG. 5a. After a successful authentication of the communication device 101 in the 5G registration in steps 503a and 503b, the access GW node 103 receives a 2^{nd} key derived from the authentication procedure from the CN node 140, e.g. the AUSF. The 2^{nd} key may be referred to as a 2^{nd} authentication key. The 2^{nd} key may be derived by the CN node 140, e.g. the AMF 105, from for example, a 2^{nd} Extended Master Session Key (EMSK), a 2^{nd} Master Session Key (MSK) etc. The 2^{nd} EMSK, the 2^{nd} MSK are 2^{nd} keys from which at least one other key can be derived. The access GW node 103 stores the received 2^{nd} key. The received 2^{nd} key may be of fixed or variable length.

Step 504b

This step is shown in FIG. 5a. After a successful authentication of the communication device 101 in the 5G registration in steps 503a and 503b, the communication device 101 generates the 2^{nd} key by its own. The communication device 101 generates the 2^{nd} key in the same way as the CN node 140, e.g. the AMF 105, generated the 2^{nd} key in step 504a. The generated 2^{nd} key may be derived from the authentication procedure. The communication device 101 stores the generated 2^{nd} key. The 2^{nd} key may be referred to as a 2^{nd} authentication key. The 2^{nd} key may be derived by the communication device 101 from for example a 2^{nd} EMSK, a 2^{nd} MSK etc. The 2^{nd} EMSK, the 2^{nd} MSK are 2^{nd} keys from which at least one other key can be derived. The generated 2^{nd} key may be of fixed or variable length.

Steps 505a

This step is shown in FIG. 5a. The communication device 101 calculates first authentication data for sending a TLS Finished message. The first authentication data is calculated based on the 2^{nd} key from step 504b and on the 1^{st} key from the previous TLS connection in steps 501 and 502. The first authentication data may be in the form of a first hash value. For example, the first authentication data may be calculated a using a master_secret basing on the 2^{nd} key from step 504b (from NAS level user authentication) and using the 1^{st} key such as a TLS secret key from steps 501 and 502 (being used on the ongoing TLS tunnel).

Step 505b

This step is shown in FIG. 5a. The communication device 101 sends the calculated first authentication data to the access GW node 103. The access GW node 103 receives the first authentication data from the communication device 101. The first authentication data may be sent in TLS Finished message comprised in a TLS Handshake message. The TLS Handshake message may further comprise a ChangeCipherSpec parameter.

Step 505c

This step is shown in FIG. 5a. The access GW node 103 calculates second authentication data for the received TLS Finished message from step 505b. The second authentication data may be in the form of a second hash value. The second authentication data may be calculated using based on the 2^{nd} key from step 504a and on the 1^{st} key from the previous TLS connection in steps 501 and 502.

The access GW node 103 verifies the second authentication data by verifying that the second authentication data and the first authentication data are substantially equal.

Step 505d

This step is shown in FIG. 5a. The access GW node 103 calculates third authentication data for sending the TLS Finished message. The third authentication data may be in the form of a third hash value. The third authentication data may be calculated based on the 2^{nd} key from step 504a and on the 1^{st} key from the previous TLS connection in steps 501 and 502.

Step 505e

This step is shown in FIG. 5b. The access GW node 103 sends the calculated third authentication data to the communication device 101. The communication device 101 receives the first authentication data from the access GW node 103. The third authentication data may be sent in a TLS Finished message comprised in a TLS Handshake message. The TLS Handshake message may further comprise a ChangeCipherSpec parameter.

Step 505f

This step is shown in FIG. 5b. The communication device 101 calculates fourth authentication data for receiving the TLS Finished message. The fourth authentication data may be in the form of a fourth hash value. The fourth authentication data may be calculated using based on the 2^{nd} key from step 504b and on the 1^{st} key from the previous TLS connection in steps 501 and 502.

The communication device 101 verifies the fourth authentication data by verifying that the fourth authentication data and the third authentication data are substantially equal.

The TLS finished message may be used for tunnel authentication when direct_tauth mode or resume_tauth_mode using the hello extension (as exemplified in step 502) has be negotiated during the TLS handshake.

When the TLS finished message is used for tunnel authentication, the verify_data may be defined as value of AUTH. The AUTH may be calculated as follows:

AUTH Calculation

AUTH=PRF(master_secret, verification_label, Hash(TLS_secret+random))[0..auth_length−1];

Hash: A Hash of the handshake messages.

For the PRF: The Hash may be the Hash used as the basis for the PRF.

Verification_label: For the messages sent by the client, the string “client verified”. For sent by the access GW node 103, e.g. the server, the string “server verified”.

Random: It is the random value in the sending TLS hello message.

TLS_Secret: This is the TLS_master_secret defined by TLS, and is being used in the current TLS connection.

master_secret=PRF(user_session_key, “tauth master secret”, random)[0..47];

user_session_key: This is derived from a NAS level user authentication procedure. For example, if EAP-AKA′ is used as a user authentication method, it can be the EMSK derived from EAP-AKA′. The derivation function for EMSK can be defined by 3GPP.

Step 505g

This step is shown in FIG. 5b. If the authentication data in the received TLS Finished message is verified at both access GW node 103 and communication device 101, the TLS connection is set authenticated. If the authentication data in the TLS Finished message is not verified at both the access GW node 103 and the communication device 101, the TLS connection is terminated and re-establishment is expected. So, if both sides successfully verify the authentication data in the received TLS Finished message, the TLS connection will be set as valid. Otherwise, it is still a pre-established TLS connection and may be terminated by the communication device 101 and/or the access GW node 103 anytime later.

Step 506

Subsequent registration procedure via non-3GPP AN 106 and other procedures such as PDU session procedures are executed. One difference for fixed access compared to other IKE/IPSEC methods for untrusted non-3GPP AN is that NAS and AS are transferred in the TLS connection between the communication device 101 and the access GW node 103.

Step 507a-507b

The subsequent NAS PDU and/or AS PDU can be transferred on the authenticated TLS connection. A N3 message comprising the NAS PDU may be transmitted from the access GW node 103 via the AMF 105 to the CN function 140.

Alternative 2—TLS Session Resume Based Connection Authentication Method

The method for TLS connection authentication according to alternative 2 will now be described with reference to the signaling diagram in FIGS. 6a and 6b. FIG. 6b is a continuation of FIG. 6a such that the method steps in FIG. 6a are performed before the method steps in FIG. 6b.

FIGS. 6a and 6b are signaling diagrams illustrating an embodiment of a method for TLS connection authentication, based on TLS session resume. The procedure is similar to the one described for FIGS. 5a and 5b, except for step 602, 605a and 605b. The method comprises at least one of the following steps, which steps may be performed in any suitable order than described below:

Step 601

This step is shown in FIG. 6a. This step corresponds to step 501 in FIG. 5a. The communication device 101 will attach to the non-3GPP AN 106 and gets configuration such as the IP address configuration.

Step 602

This step is shown in FIG. 6a. This step is similar to step 502 in FIG. 5a, except that the resume_tauth_mode is negotiated in FIG. 6a.

In step 602, the communication device 101 performs a TLS handshake with the access GW node 103 to setup the TLS connection. During the handshake, the access GW node authentication is usually required and the access GW node certificate may be provided to the communication device 101. The communication device authentication is not required and it is not required to provide the communication device certificate to the access GW node 103. Communication device authentication will be deferred to NAS registration phase. TLS connection authentication mode for communication device authentication is negotiated using TLS hello extension. Note that negotiation of connection authentication method is optional.

A 1^{st} key is used during the TLS connection establishment in step 602. The 1^{st} key may be referred to as a 1^{st} authentication key, a 1^{st} security key etc. The 1^{st} key may be based on a TLS_secret parameter, which will be described in more detail later. Both the communication device 101 and the access GW node 103 generate the 1^{st} key when the ongoing TLS connection is setup. The 1^{st} and 2^{nd} keys are different keys, generated at different occasions and based on different input. The communication device 101 and the access GW node 103 may need to prove they have both these two keys and this may be done by calculating the authentication data based on both these keys.

Step 603

Registration via non-3GPP AN is performed, and this is done with steps 603a and 603b described below.

Step 603a

This step is shown in FIG. 6a. This step corresponds to step 503a in FIG. 5a. After the TLS connection has been pre-established since one-way authentication is done only without communication device authenticated, at least one of the NAS PDU and/or the AS PDU is transferred from the communication device 101, via the TLS connection, to the access GW node 103 for 5G registration and communication device authentication using 3GPP credential.

Step 603b

This step is shown in FIG. 6a. The access GW node 103may send at least one N3 message to the CN function 140, e.g. via the AMF 105. The N3 message may comprise the NAS PDU.

Step 604a

This step is shown in FIG. 6a. After a successful authentication of the communication device 101 in the 5G registration in steps 603a and 603b, the access GW node 103 receives a 2^{nd} key derived from the authentication procedure from the CN node 140, e.g. the AUSF. The 2^{nd} key may be referred to as a 2^{nd} authentication key. The 2^{nd} key may be derived by the CN node 140, e.g. the AMF 105, from for example a 2^{nd} EMSK), a 2^{nd} MSK etc. The 2^{nd} EMSK, the 2^{nd} MSK are 2^{nd} keys from which at least one other key can be derived. The access GW node 103 stores the received 2^{nd} key. The received 2^{nd} key may be of fixed or variable length.

Step 604b

This step is shown in FIG. 6a. After a successful authentication of the communication device 101 in the 5G registration in steps 503a and 503b, the communication device 101 generates a 2^{nd} key by its own. The communication device 101 generates the 2^{nd} key in the same way as the CN node 140, e.g. the AMF 105, generated the 2^{nd} key in step 604a. The generated 2^{nd} key may be derived from the authentication procedure. The communication device 101 stores the generated 2^{nd} key. The 2^{nd} key may be referred to as a 2^{nd} authentication key. The 2^{nd} key may be derived by the communication device 101 from for example 2^{nd} EMSK, a 2^{nd} MSK etc. The 2^{nd} EMSK, the 2^{nd} MSK are 2^{nd} keys from which at least one other key may be derived. The generated 2^{nd} key may be of fixed or variable length.

Step 605a

This step is seen in FIG. 6a. This step does not have a corresponding step in FIG. 5a. This is an optional step. In step 605a, the access GW node 103 may request the communication device 101 to resume the TLS session for connection authentication purpose. This may be done by sending a TLS handshake message from the access GW node 103 to the communication device 101. The TLS handshake message may comprise a Hello Request parameter.

Step 605b

This step is seen in FIG. 6a. This step does not have a corresponding step in FIG. 5a. The communication device 101 will resume TLS by initiating TLS handshake client hello which including the TLS session id to resume. This may be done by that the communication device 101 sends a TLS handshake message to the access GW node 103. The TLS handshake message comprises a Client Hello parameter.

If resume failure meaning the TLS session id is not found by the access GW node 103, the full TLS setup procedure may be performed except that the authentication data, e.g. the verify_data parameter in the TLS Finished messages, calculation and usage will be followed.

Step 605c

This step is shown in FIG. 6a. This step corresponds to step 505d in FIG. 5a. The access GW node 103 calculates third authentication data for sending a TLS Finished message. The third authentication data is calculated based on the 1^{st} key and the 2^{nd} key from step 604a. The third authentication data may be in the form of a third hash value. For example, the 1^{st} key may be based on a TLS_secret parameter based on an authentication key from the previous TLS connection in steps 601-602, and the 2^{nd} key may be for example based on a master_secret parameter.

Step 605d

This step is shown in FIG. 6a. This step corresponds to step 505e in FIG. 5b. The access GW node 103 sends the calculated third authentication data to the communication device 101. The communication device 101 receives the third authentication data from the access GW node 103. The third authentication data may be sent in TLS Finished message comprised in a TLS Handshake message. The TLS Handshake message may further comprise a ServerHello parameter and/or a ChangeCipherSpec parameter.

Step 605e

This step is shown in FIG. 6a. This step corresponds to step 505f in FIG. 5b. The communication device 101 calculates fourth authentication data for receiving the TLS Finished message. The fourth authentication data may be in the form of a fourth hash value. The fourth authentication data may be calculated using the 1^{st} and 2^{nd} keys.

The communication device 101 verifies the fourth authentication data by verifying that the fourth authentication data and the third authentication data are substantially equal.

Steps 605f

This step is shown in FIG. 6b. This step corresponds to step 505a. The communication device 101 calculates first authentication data for sending a TLS Finished message. The first authentication data is calculated based on the 1^{st} and 2^{nd} keys. The first authentication data may be in the form of a first hash value.

Step 605g

This step is shown in FIG. 6b. The communication device 101 sends the calculated first authentication data to the access GW node 103. The access GW node 103 receives the first authentication data from the communication device 101. The first authentication data may be sent in TLS Finished message comprised in a TLS Handshake message. The TLS Handshake message may further comprise a ChangeCipherSpec parameter.

Step 605h

This step is shown in FIG. 6b. This step corresponds to step 505c in FIG. 5a. The access GW node 103 calculates second authentication data for the received TLS Finished message from step 605g. The second authentication data may be in the form of a second hash value. The second authentication data may be calculated the 1^{st} and 2^{nd} keys.

The access GW node 103 verifies the second authentication data by verifying that the second authentication data and the first authentication data are substantially equal.

Step 605i

This step is shown in FIG. 6b. This step corresponds to step 505g in FIG. 5b. If the authentication data in the received TLS Finished message is verified at both access GW node 103 and communication device 101, the TLS connection is set authenticated. If the authentication data in the TLS Finished message is not verified at both the access GW node 103 and the communication device 101, the TLS connection is terminated and re-establishment is expected. So, if both sides successfully verify the authentication data in the received TLS Finished message, the TLS connection will be set as valid. Otherwise, it is still a pre-established connection and may be terminated by the communication device 101 and/or the access GW node 103 anytime later.

Step 606

Subsequent registration procedure via the non-3GPP AN 106 and other procedures such as PDU session procedures are executed. One difference for fixed access compared to other IKE/IPSEC methods for untrusted non-3GPP AN is that NAS and AS are transferred in the TLS connection between the communication device 101 and the access GW node 103.

Step 607a-607b

The subsequent NAS PDU and/or AS PDU can be transferred on the authenticated TLS connection. A N3 message comprising the NAS PDU may be transmitted from the access GW node 103 via the AMF 105 to the CN function 140.

Alternative 3 TLS Heartbeat Based Connection Authentication Method

The method for TLS connection authentication according to alternative 3 will now be described with reference to the signaling diagram in FIGS. 7a and 7b. FIG. 7b is a continuation of FIG. 7a such that the method steps in FIG. 7a are performed before the method steps in FIG. 7b.

FIGS. 7a and 7b are signaling diagrams illustrating an embodiment of a method for TLS connection authentication, based on TLS Heartbeat. The procedure is similar to the one described for FIGS. 5a and 5b, except for step 702, 705a and 705d. The method comprises at least one of the following steps, which steps may be performed in any suitable order than described below:

Step 701

This step is shown in FIG. 7a. This step corresponds to step 501 in FIG. 5a and step 601 in FIG. 6a. The communication device 101 will attach to the non-3GPP AN 106 and gets configuration such as the IP address configuration.

Step 702

This step is shown in FIG. 7a. This step is similar to step 502 in FIG. 5a and step 602 in FIG. 6a, except that the heartbeat_tauth_mode is negotiated in FIG. 7a.

In step 702, the communication device 101 performs a TLS handshake with the access GW node 103 to setup the TLS connection. During the handshake, the access GW node authentication is usually required and the access GW node certificate may be provided to the communication device 101. The communication device authentication is not required and it is not required to provide the communication device certificate to the access GW node 103. Communication device authentication will be deferred to NAS registration phase. TLS connection authentication mode for communication device authentication is negotiated using TLS hello extension. In this alternative 3, heartbeat_tauth_mode is negotiated. Note that negotiation of connection authentication method is optional.

A 1^{st} key is used during the TLS connection establishment in step 702. The 1^{st} key may be referred to as a 1^{st} authentication key, a 1^{st} security key etc. The 1^{st} key may be based on a TLS_secret parameter, which will be described in more detail later. Both the communication device 101 and the access GW node 103 generate the 1^{st} key when the ongoing TLS connection is setup. The 1^{st} and 2^{nd} keys are different keys, generated at different occasions and based on different input. The communication device 101 and the access GW node 103 may need to prove they have both these two keys and this may be done by calculating the authentication data based on both these keys.

Step 703a

This step is shown in FIG. 7a. This step corresponds to step 503a in FIG. 5a and step 603a in FIG. 6a. After the TLS connection has been pre-established since one-way authentication is done only without communication device authenticated, at least one of the NAS PDU and/or the AS PDU is transferred from the communication device 101, via the TLS connection, to the access GW node 103 for 5G registration and communication device authentication using 3GPP credential. A difference for the fixed access compared to other IKE/IPSEC methods for untrusted non-3GPP AN is that the NAS and AS are transferred in the TLS connection between the communication device 101 and the access GW node 103.

Step 703b

This step is shown in FIG. 7a. This step corresponds to step 503b in FIG. 5a and step 603b in FIG. 6a. The access GW node 103 may send an N3 message to the CN function 140, e.g. via the AMF 105. The N3 message may comprise the NAS PDU.

Step 704a

This step is shown in FIG. 7a. This step corresponds to step 504a in FIG. 5a and step 604a in FIG. 6a. After a successful authentication of the communication device 101 in the 5G registration in steps 703a and 703b, the access GW node 103 receives a 2^{nd} key derived from the authentication procedure from the CN node 140, e.g. the AUSF. The 2^{nd} key may be referred to as a 2^{nd} authentication key. The 2^{nd} key may be derived by the CN node 140, e.g. the AMF 105, from for example a 2^{nd} EMSK, a 2^{nd} MSK etc. The 2^{nd} EMSK, the 2^{nd} MSK are 2^{nd} keys from which at least one other key can be derived. The access GW node 103 stores the received 2^{nd} key. The received 2^{nd} key may be of fixed or variable length.

Step 704b

This step is shown in FIG. 7a. This step corresponds to step 504b in FIG. 5a and step 604b in FIG. 6a. After a successful authentication of the communication device 101 in the 5G registration in steps 703a and 703b, the communication device 101 generates a 2^{nd} key by its own. The communication device 101 generates the 2^{nd} key in the same way as the CN node 140, e.g. the AMF 105, generated the 2^{nd} key in step 704a. The generated 2^{nd} key may be derived from the authentication procedure. The communication device 101 stores the generated 2^{nd} key. The 2^{nd} key may be referred to as a 2^{nd} authentication key. The 2^{nd} key may be derived by the communication device 101 from for example a 2^{nd} EMSK, a 2^{nd} MSK etc. The 2^{nd} EMSK, the 2^{nd} MSK are 2^{nd} keys from which at least one other key can be derived. The generated 2^{nd} key may be of fixed or variable length.

Step 705

This step is shown in FIG. 7a. This step corresponds to step 505a in FIG. 5a and step 605f in FIG. 6b. The communication device 101 calculates first authentication data for sending a TLS Finished message. The first authentication data is calculated based on 1^{st} and 2^{nd} keys. The first authentication data may be in the form of a first authentication (auth) value. For example, the 1^{st} key may be based on a TLS_secret parameter based on an authentication key from the previous TLS connection in steps 601-602, and the 2^{nd} key may be for example based on a master_secret parameter.

Step 705a

This step is shown in FIG. 7a. This step does not have a corresponding step in FIG. 5a or FIG. 6a. The TLS heartbeat message is used to carry authentication data, e.g. in the verify_data parameter in the heartbeat message. In other words, the communication device 101 sends a TLS Heartbeat request message to the access GW node 103. The TLS heartbeat request message comprises the first authentication data.

Step 705b

This step is shown in FIG. 7a. This step corresponds to step 505c in FIG. 5a and step 605h in FIG. 6b. The access GW node 103 calculates second authentication data for the received TLS heartbeat message from step 705a. The second authentication data may be in the form of a second auth value. The second authentication data may be calculated based on the 1^{st} and 2^{nd} keys.

The access GW node 103verifies the second authentication data by verifying that the second authentication data and the first authentication data are substantially equal.

Step 705c

This step is shown in FIG. 7a. This step corresponds to step 505d in FIG. 5a and step 605c in FIG. 6a. The access GW node 103 calculates third authentication data for sending the TLS heartbeat message. The third authentication data may be in the form of a third auth value. The third authentication data may be calculated based on the 1^{st} and 2^{nd} keys.

Step 705d

This step is shown in FIG. 7a. This step does not have a corresponding step in FIG. 5a or FIG. 6a. The TLS heartbeat message is used to carry authentication data, e.g. in the verify_data parameter in the heartbeat message. In other words, the access GW node 103 sends a TLS Heartbeat response message to the communication device 101. The TLS heartbeat request message comprises the third authentication data.

Step 705e

This step is shown in FIG. 7b. This step corresponds to step 505f in FIG. 5b and step 605e in FIG. 6a. The communication device 101 calculates fourth authentication data for receiving the TLS heartbeat message. The fourth authentication data may be in the form of a fourth auth value. The fourth authentication data may be calculated based on the 1^{st} and 2^{nd} keys.

The communication device 101 verifies the fourth authentication data by verifying that the fourth authentication data and the third authentication data are substantially equal.

An example of the heartbeat messages will now be provided. The extension heartbeat messages may be used only when the heartbeat_tauth mode using hello extension (as exemplified in step 502) has be negotiated during the TLS handshake.

struct {
HeartbeatMessageType type;
uint16 verify_length;
opaque verify_payload[verify_length];
uint16 payload_length;
opaque payload[HeartbeatMessage.payload_length];
opaque padding[padding_length];
} HeartbeatMessage;

The verify_payload value exemplified in step 502 as AUTH value.

Step 706

This step is shown in FIG. 7b. This step corresponds to step 505g in FIG. 5b and step 605i in FIG. 6b. If the received TLS heartbeat message is verified at both access GW node 103 and communication device 101, the TLS connection is set authenticated. If the TLS heartbeat message is not verified at both the access GW node 103 and the communication device 101, the TLS connection is terminated and re-establishment is expected. So, if both sides successfully verify the authentication data in the receiving TLS heartbeat message, the TLS connection will be set as valid. Otherwise, it is still a pre-established connection and may be terminated by the communication device 101 and/or the access GW node 103 anytime later.

Step 707

This step is shown in FIG. 7b. This step corresponds to step 506 in FIG. 5b and step 606 in FIG. 6b. Subsequent registration procedure via non-3GPP AN 106 and other procedures such as PDU session procedures are executed. One difference for fixed access compared to other IKE/IPSEC methods for untrusted non-3GPP AN is that NAS and AS are transferred in the TLS connection between the communication device 101 and the access GW node 103.

Step 707a-707b

This step is shown in FIG. 7b. This step corresponds to steps 507a-507b in FIG. 5b and steps 606a-606b in FIG. 6n. The subsequent NAS PDU and/or AS PDU can be transferred on the authenticated TLS connection. A N3 message comprising the NAS PDU may be transmitted from the access GW node 103 via the AMF 105 to the CN function 140.

Alternative 4—TLS Inline Message Based Connection Authentication Method

The method for TLS connection authentication according to alternative 4 will now be described with reference to the signaling diagram in FIGS. 8a and 8b. FIG. 8b is a continuation of FIG. 8a such that the method steps in FIG. 8a are performed before the method steps in FIG. 8b.

FIGS. 8a and 8b are signaling diagrams illustrating an embodiment of a method for TLS connection authentication, based on TLS inline message. The procedure is similar to the one described for FIGS. 5a and 5b, except for step 802, 805b and 805e. The method comprises at least one of the following steps, which steps may be performed in any suitable order than described below:

Step 801

This step is shown in FIG. 8a. This step corresponds to step 501 in FIG. 5a, step 601 in FIG. 6a and step 701 in FIG. 7a. The communication device 101 will attach to the non-3GPP AN 106 and gets configuration such as the IP address configuration.

Step 802

This step is shown in FIG. 8a. This step is similar to step 502 in FIG. 5a, step 602 in FIG. 6a and step 702 in FIG. 7a. except that the inline_tauth_mode is negotiated in FIG. 8a.

In step 802, the communication device 101 performs a TLS handshake with the access GW node 103 to setup the TLS connection. During the handshake, the access GW node authentication is usually required and the access GW node certificate may be provided to the communication device 101. The communication device authentication is not required and it is not required to provide the communication device certificate to the access GW node 103. Communication device authentication will be deferred to NAS registration phase. TLS connection authentication mode for communication device authentication is negotiated using inline_tauth_mode. In this alternative 4, inline_tauth_mode is negotiated. Note that negotiation of connection authentication method is optional.

A 1^{st} key is used during the TLS connection establishment in step 801. The 1^{st} key may be referred to as a 1^{st} authentication key, a 1^{st} security key etc. The 1^{st} key may be based on a TLS_secret parameter, which will be described in more detail later. Both the communication device 101 and the access GW node 103 generate the 1^{st} key when the ongoing TLS connection is setup. The Pt and 2^{nd} keys are different keys, generated at different occasions and based on different input. The communication device 101 and the access GW node 103 may need to prove they have both these two keys and this may be done by calculating the authentication data based on both these keys.

Step 803a

This step is shown in FIG. 8a. This step corresponds to step 503a in FIG. 5a, step 603a in FIG. 6a and step 703a in FIG. 7a. After the TLS connection has been pre-established since one-way authentication is done only without communication device authenticated, at least one of the NAS PDU and/or the AS PDU is transferred from the communication device 101, via the TLS connection, to the access GW node 103 for 5G registration and communication device authentication using 3GPP credential. A difference for the fixed access compared to other IKE/IPSEC methods for untrusted non-3GPP AN is that the NAS and AS are transferred in the TLS connection between the communication device 101 and the access GW node 103.

Step 803b

This step is shown in FIG. 8a. This step corresponds to step 503b in FIG. 5a, step 603b in FIG. 6a and step 703b in FIG. 7a. The access GW node 103 may send an N3 message to the CN function 140, e.g. via the AMF 105. The N3 message may comprise the NAS PDU.

Step 804a

This step is shown in FIG. 8a. This step corresponds to step 504a in FIG. 5a, step 604a in FIG. 6a and step 704a in FIG. 7a. After a successful authentication of the communication device 101 in the 5G registration in steps 803a and 803b, the access GW node 103 receives a 2^{nd} key derived from the authentication procedure from the CN node 140, e.g. the AUSF. The 2^{nd} key may be referred to as a 2^{nd} authentication key. The 2^{nd} key may be derived by the CN node 140, e.g. the AMF 105, from for example a 2^{nd} EMSK, a 2^{nd} MSK etc. The 2^{nd} EMSK, the 2^{nd} MSK are 2^{nd} keys from which at least one other key can be derived. The access GW node 103 stores the received 2^{nd} key. The received 2^{nd} key may be of fixed or variable length.

Step 804b

This step is shown in FIG. 8a. This step corresponds to step 504b in FIG. 5a, step 604b in FIG. 6a and step 704b in FIG. 7a. After a successful authentication of the communication device 101 in the 5G registration in steps 803a and 803b, the communication device 101 generates a 2^{nd} key by its own. The communication device 101 generates the 2^{nd} key in the same way as the CN node 140, e.g. the AMF 105, generated the 2^{nd} key in step 804a. The generated 2^{nd} key may be derived from the authentication procedure. The communication device 101 stores the generated 2^{nd} key. The 2^{nd} key may be referred to as a 2^{nd} authentication key. The 2^{nd} key may be derived by the communication device 101 from for example a 2^{nd} EMSK, a 2^{nd} MSK etc. The 2^{nd} EMSK, the 2^{nd} MSK are 2^{nd} keys from which at least one other key can be derived. The generated 2^{nd} key may be of fixed or variable length.

Step 805a

This step is shown in FIG. 8a. This step corresponds to step 505a in FIG. 5a, step 605f in FIG. 6b and step 705 in FIG. 7a. The communication device 101 calculates first authentication data for sending a TLS data message. The first authentication data is calculated based on the 1^{st} and 2^{nd} keys. The first authentication data may be in the form of a first hash value.

Step 805b

This step is shown in FIG. 8a. This does not have a corresponding step in FIG. 5a, FIG. 6a or FIG. 7a. An AS specific protocol message or PDU is used to carry authentication data, e.g. the in AUTH field of the message. Using other words, the communication device 101 sends AS PDU over the TLS connection to the access GW node 103. The AS PDU may be sent in a Connection Authentication request message together with the first authentication data.

Step 805c

This step is shown in FIG. 8a. This step corresponds to step 505c in FIG. 5a, step 605h in FIG. 6b and step 705b in FIG. 7a. The access GW node 103 calculates second authentication data for the received TLS data message from step 505b. The second authentication data may be in the form of a second hash value. The second authentication data may be calculated based on the 1^{st} and 2^{nd} keys.

The access GW node 103 verifies the second authentication data by verifying that the second authentication data and the first authentication data are substantially equal.

Step 805d

This step is shown in FIG. 8b. This step corresponds to step 505d in FIG. 5a, step 605c in FIG. 6a and step 705c in FIG. 7a. The access GW node 103 calculates third authentication data for sending the TLS data message. The third authentication data may be in the form of a third hash value. The third authentication data may be calculated using the first and 2^{nd} keys.

Step 805e

This step is shown in FIG. 8b. This does not have a corresponding step in FIG. 5a, FIG. 6a or FIG. 7a. An AS specific protocol message or PDU is used to carry authentication data, e.g. the in AUTH parameter of the message. Using other words, the access GW node 103 sends the AS PDU over the TLS connection to the communication device 101. The AS PDU may be sent in a Connection Authentication response message together with the third authentication data.

The inline tunnel authentication mode may be used when inline_tauth_mode using hello extension has been negotiated during the TLS handshake. The AUTH value calculation is exemplified in step 505f.

The AUTH calculation is same definition in section step 505f expect those specified in following. The content of the HASH is the TLS application-data message that is carrying the line message.

Step 805f

This step is shown in FIG. 8b. This step corresponds to step 505f in FIG. 5a, step 605e in FIG. 6a and step 705e in FIG. 7b. The communication device 101 calculates fourth authentication data for receiving the TLS data message. The fourth authentication data may be in the form of a fourth hash value. The fourth authentication data may be calculated based on the 1^{st} and 2^{nd} keys.

The communication device 101 verifies the fourth authentication data by verifying that the fourth authentication data and the third authentication data are substantially equal.

Step 805g

This step is shown in FIG. 8b. This step corresponds to step 505g in FIG. 5b, step 605i in FIG. 6b and step 706 in FIG. 7b. If the authentication data in the received TLS data message is verified at both access GW node 103 and communication device 101, the TLS connection is set authenticated. If the authentication data in the TLS data message is not verified at both the access GW node 103 and the communication device 101, the TLS connection is terminated and re-establishment is expected. So, if both sides successfully verify the authentication data in the receiving TLS data message, the TLS connection will be set as valid. Otherwise, it is still a pre-established connection and may be terminated by the communication device 101 and/or the access GW node 103 anytime later.

Step 806

This step is shown in FIG. 8b. This step corresponds to step 506 in FIG. 5b,

step 606 in FIG. 6b and step 707 in FIG. 7b. Subsequent registration procedure via non-3GPP AN 106 and other procedures such as PDU session procedures are executed. One difference for fixed access compared to other IKE/IPSEC methods for untrusted non-3GPP AN is that NAS and AS are transferred in the TLS connection between the communication device 101 and the access GW node 103.

Step 807a-807b

This step is shown in FIG. 8b. This step corresponds to steps 507a-507b in FIG. 5b, step 606a-606b in FIG. 6b and steps 707a-707b in FIG. 7b. The subsequent NAS PDU and/or AS PDU can be transferred on the authenticated TLS connection. A N3 message comprising the NAS PDU may be transmitted from the access GW node 103 via the AMF 105 to the CN function 140.

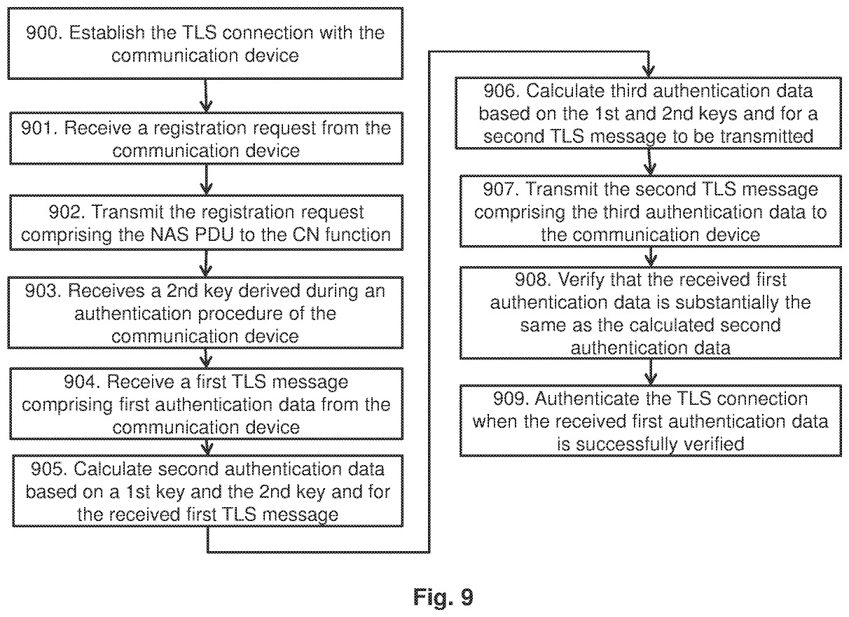

For all the alternatives 1-4 above, the following applies for TLS connection maintenance Both the communication node 101 and the access GW node 103 can initiate TLS heartbeat messages for keeping the TLS connection alive. Both the communication device 101 and the access GW node 103 can send a TLS close_notify alert message according to the TLS profile specified in 3GPP TS 33.310 annex E to release an TLS connection, for example when the upper AS level connection is closed. The method described above will now be described seen from the perspective of the access GW node 103 of a non-3GPP access. FIG. 9 is a flowchart describing the present method performed by the access GW node 103 for authentication of the TLS connection, between the access GW node 103 and the communication device 101. The access GW node may be a N3IWF 103a, an AGF 103b, or a FGAF.

The method comprises at least one of the following steps to be performed by the access GW node 103, which steps may be performed in any suitable order than described below:

Step 900

This step corresponds to steps 501-502 in FIG. 5a, steps 601-602 in FIG. 6a, steps 701-702 in FIG. 7a and steps 801-802 in FIG. 8a. The access GW node 103 may establish the TLS connection with the communication device 101. The establishment of the TLS connection may also be referred to as a setup of the TLS connection.

Step 901

This step corresponds to step 503a in FIG. 5a, steps 603 and 603a in FIG. 6a, steps 703 and 703a in FIG. 7a and steps 803 and 803a in FIG. 8a. The access GW node 103 may receive a registration request from the communication device 101 via the TLS connection. The registration request may comprise a NAS PDU, and/or an AS PDU.

Step 902

This step corresponds to step 503b in FIG. 5a, step 603b in FIG. 6a, step 703b in FIG. 7a and step 803b in FIG. 8a. The access GW node 103 may transmit the registration request comprising the NAS PDU to the CN function 140.

Step 903

This step corresponds to step 400 in FIG. 4, step 504a in FIG. 5a, step 604a in FIG. 6a, step 704a in FIG. 7a and step 804a in FIG. 8a. The access GW node 103 receives, from a CN function 140, a 2^{nd} key derived during an authentication procedure of the communication device 101.

The 2^{nd} key may be based on at least one of an EMSK, a MSK and a master_secret key.

Step 904

This step corresponds to step 403 in FIG. 4, step 505b in FIG. 5a, step 605g in FIG. 6a, step 705a in FIG. 7a and step 805b in FIG. 8a. The access GW node 103 receives a first TLS message comprising first authentication data from the communication device 101.

The received first TLS message may be a received first TLS finished message, or a received first TLS heartbeat message, or a received first TLS Data message.

The first authentication data may comprise a first Hash parameter or a first Auth parameter.

Step 905

This step corresponds to step 404 in FIG. 4, step 505c in FIG. 5a, step 605h in FIG. 6a, step 705b in FIG. 7a and step 805c in FIG. 8a. The access GW node 103 calculates second authentication data based on a 1^{st} key and the 2^{nd} key and for the received first TLS message. The 1^{st} key is associated with the TLS connection. Both the communication device 101 and the access GW node 103 may generate the 1^{st} key when the ongoing TLS connection is established.

The second authentication data may comprise a second Hash parameter or a second Auth parameter.

The 1^{st} and 2^{nd} keys are different keys, generated at different occasions and based on different input. The communication device 101 and the access GW node 103 may need to prove they have both these two keys and this may be done by calculating the authentication data based on both these keys.

Step 906

This step corresponds to step 405 in FIG. 4, step 505d in FIG. 5a, step 605c in FIG. 6a, step 705c in FIG. 7a and step 805d in FIG. 8b. The access GW node 103 calculates third authentication data based on the 1^{st} and 2^{nd} keys and for a second TLS message to be transmitted.

The third authentication data may comprise a third Hash parameter or a third Auth parameter.

Step 907

This step corresponds to step 406 in FIG. 4, step 505e in FIG. 5, step 605d in FIG. 6a, step 705d in FIG. 7a and step 805e in FIG. 8b. The access GW node 103 transmits the second TLS message comprising the third authentication data to the communication device 101.

The transmitted second TLS message may be a transmitted second TLS finish message or a transmitted second TLS heartbeat message or a transmitted second TLS data message.

Step 908

This step corresponds to step 407 in FIG. 4, step 505c in FIG. 5a, step 605h in FIG. 6b, step 705b in FIG. 7a and step 805b in FIG. 8s. The access GW node 103 verifies that the received first authentication data is substantially the same as the calculated second authentication data.

Step 909

This step corresponds to step 410 in FIG. 5, step 505g in FIG. 5b, step 605i in FIG. 6b, step 706 in FIG. 7b and step 805g FIG. 8b. The access GW node 103 authenticates the TLS connection when the received first authentication data is successfully verified.

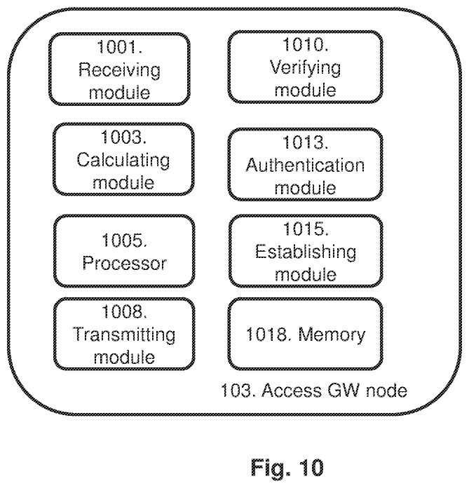

To perform the method steps shown in FIGS. 4-9 for for authentication of a TLS connection between the access GW node 103 and the communication device 101, the access GW node 103 may comprise an arrangement as shown in FIG. 10. The access GW node 103 may be a N3IWF 103a, an AGF 103b, or a FGAF.

The access GW node 103 is configured to, e.g. by means of a receiving module 1001, receive, from a CN function 140, a 2^{nd} key derived during an authentication procedure of a communication device 101. The 2^{nd} key may be based on at least one of an EMSK, a MSK and a master_secret key. The received first TLS message may be a received first TLS finished message, or a received first TLS heartbeat message, or a received first TLS Data message 805b. The receiving module 1001 may also be referred to as a receiving unit, a receiving means, a receiving circuit, means for receiving, input unit etc. The receiving module 1001 may be a receiver, a transceiver etc. The receiving module 1001 may be a wireless receiver of the access GW node 103 of a wireless or fixed communications system.

The access GW node 103 is configured to, e.g. by means of the receiving module 1001, receive a first TLS message comprising first authentication data from the communication device 101. The first authentication data may comprise a first Hash parameter or a first Auth parameter,

The access GW node 103 is configured to, e.g. by means of a calculating module 1003, calculate second authentication data based on a 1^{st} key and the 2^{nd} key and for the received first TLS, message. The 1^{st} key is associated with a TLS connection between the access GW node 103 and the communication device 101. The second authentication data may comprise a second Hash parameter or a second Auth parameter. The calculating module 1003 may also be referred to as a calculating unit, a calculating means, a calculating circuit, means for calculating etc. The calculating module 1003 may be a processor 1005 of the access GW node 103 or comprised in the processor 1005 of the access GW node 103.

The access GW node 103 is configured to, e.g. by means of the calculating module 1003, calculate third authentication data based on the 1^{st} and 2^{nd} keys and for a second TLS message to be transmitted. The third authentication data may comprise a third Hash parameter or a third Auth parameter.

The access GW node 103 is configured to, e.g. by means of a transmitting module 1008, transmit the second TLS message comprising the third authentication data to the communication device 101. The transmitted second TLS message may be a transmitted second TLS finish message or a transmitted second TLS heartbeat message or a transmitted second TLS data message. The transmitting module 1008 may also be referred to as a transmitting unit, a transmitting means, a transmitting circuit, means for transmitting, output unit etc. The transmitting module 1008 may be a transmitter, a transceiver etc. The transmitting module 1008 may be a wireless transmitter of the access GW node 103 of a wireless or fixed communications system.

The access GW node 103 is configured to, e.g. by means of a verifying module 1010, verify that the received first authentication data is substantially the same as the calculated second authentication data. The verifying module 1010 may also be referred to as a verifying unit, a verifying means, a verifying circuit, means for verifying etc. The verifying module 1010 may be the processor 1005 of the access GW node 103 or comprised in the processor 1005 of the access GW node 103.

The access GW node 103 is configured to, e.g. by means of an authentication module 1013, authenticate the TLS connection between the access GW node 103 and a communication device 101 when the received first authentication data is successfully verified. The authentication module 1013 may also be referred to as an authentication unit, an authentication means, an authentication circuit, means for authentication etc. The authentication module 1013 may be the processor 1005 of the access GW node 103 or comprised in the processor 1005 of the access GW node 103.

The access GW node 103 may be configured to, e.g. by means of an establishing module 1015, establish the TLS connection with the communication device 101. The establishing module 1015 may also be referred to as an establishing unit, an establishing means, an establishing circuit, means for establishing etc. The establishing module 1015 may be the processor 1005 of the access GW node 103 or comprised in the processor 1005 of the access GW node 103.

The access GW node 103 may be configured to, e.g. by means of the receiving module 1001, receive a registration request from the communication device 101 via the TLS connection. The registration request may comprise a NAS PDU, and/or an AS PDU.

The access GW node 103 may be configured to, e.g. by means of the transmitting module 1008, transmit the registration request comprising the NAS PDU to the CN function 140.

The access GW node 103 may comprise a memory 1018. The memory 1018 comprises instructions executable by the processor 1005.

A first computer program may comprise instructions which, when executed on at least one processor, cause the at least one processor to carry out the method steps 900-909. A first carrier may comprise the first computer program, and the first carrier is one of an electronic signal, optical signal, radio signal or computer readable storage medium.

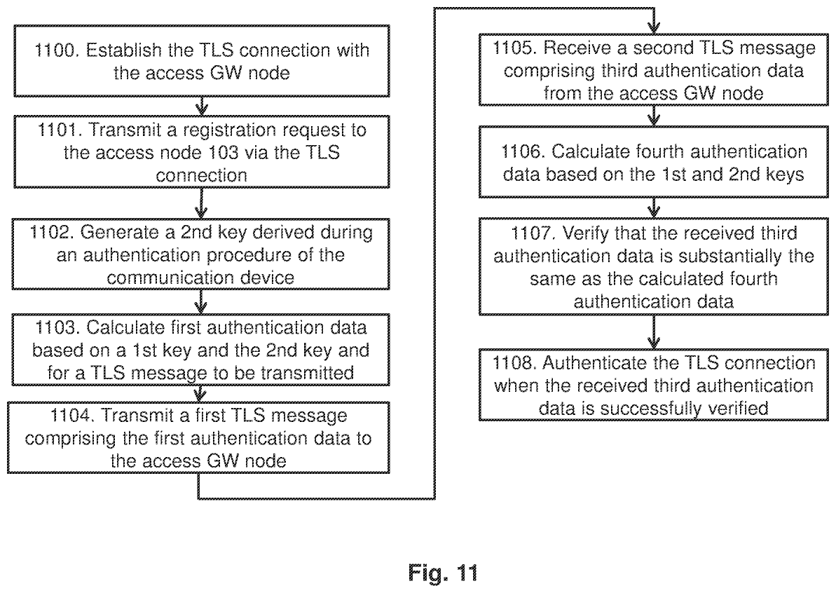

The method described above will now be described seen from the perspective of the communication device 101 of a non-3GPP access. FIG. 11 is a flowchart describing the present method performed by the communication device 101 for authentication of a TLS connection between the access GW node 103 and the communication device 101. The communication device 101 may be a UE 101a or a RG 101b. The method comprises at least one of the following steps to be performed by the communication device 101, which steps may be performed in any suitable order than described below:

Step 1100

This step corresponds to steps 501-502 in FIG. 5a, steps 601-602 in FIG. 6a, steps 701-702 in FIG. 7a and steps 801-802 in FIG. 8a. The communication device 101 may establish the TLS connection with the access GW node 103.

Step 1101

This step corresponds to 503a in FIG. 5a, step 603 and step 603a in FIG. 6a, steps 703 and 703a in FIG. 7a and steps 803 and 803a in FIG. 8a. The communication device 101 may transmit a registration request to the access node 103 via the TLS connection. The registration request comprises a NAS PDU and/or an AS PDU.

Step 1102

This step corresponds to step 401 in FIG. 4, step 504b in FIG. 5a, step 604b in FIG. 6a, step 704b in FIG. 7a and step 804b in FIG. 8a. The communication device 101 generates a 2^{nd} key derived during an authentication procedure of the communication device 101.

The 2^{nd} key may be based on at least one of an EMSK, a MSK and a master_secret key.

Step 1103

This step corresponds to step 402 in FIG. 4, step 505a in FIG. 5a, step 605f in FIG. 6a, step 705 in FIG. 7a and step 805a in FIG. 8a. The communication device 101 calculates first authentication data based on a 1^{st} key and the 2^{nd} key and for a TLS message to be transmitted. The 1^{st} key is associated with the TLS connection;

The first authentication data may comprise a first Hash parameter or a first Auth parameter.

Both the communication device 101 and the access GW node 103 may generate the 1St key when the ongoing TLS connection is established.

The 1^{st} and 2^{nd} keys are different keys, generated at different occasions and based on different input. The communication device 101 and the access GW node 103 may need to prove they have both these two keys and this may be done by calculating the authentication data based on both these keys.

Step 1104

This step corresponds to step 403 in FIG. 4, step 505b in FIG. 5a, step 605g in FIG. b, step 705a in FIG. 7a and step 805b in FIG. 8a. The communication device 101 transmits a first TLS message comprising the first authentication data to the access GW node 103.

The transmitted first TLS message may be a transmitted first TLS finished message, or a transmitted first TLS heartbeat message, or a transmitted first TLS Data message.

Step 1105

This step corresponds to step 406 in FIG. 4, step 505e in FIG. 5b, step 605d in FIG. 6a, step 705d FIG. 7a and step 805e in FIG. 8b. The communication device 101 receives a second TLS message comprising third authentication data from the access GW node 103.

The received second TLS message may be a received second TLS finish message or a received second TLS heartbeat message or a received second TLS data message.

The third authentication data may comprise a third Hash parameter or a third Auth parameter.

Step 1106

This step corresponds to step 408 in FIG. 4, step 505f in FIG. 5b, step 605e in FIG. 6a, step 705e in FIG. 7b and step 805f in FIG. 8b. The communication device 101 calculates fourth authentication data based on the 1^{st} and 2^{nd} keys.

The fourth authentication data may comprise a fourth Hash parameter or a fourth Auth parameter.

Step 1107

This step corresponds to step 409 in FIG. 4, step 505f in FIG. 5b, step 605e in FIG. 6a, step 705e in FIG. 7b and step 805f in FIG. 8b. The communication device 101 verifies that the received third authentication data is substantially the same as the calculated fourth authentication data.

Step 1108

This step corresponds to step 410 in FIG. 4, step 505g in FIG. 5b, step 605i in FIG. 6b, step 706 in FIG. 7b and step 805g in FIG. 8b. The communication device 101 authenticates the TLS connection when the received third authentication data is successfully verified.

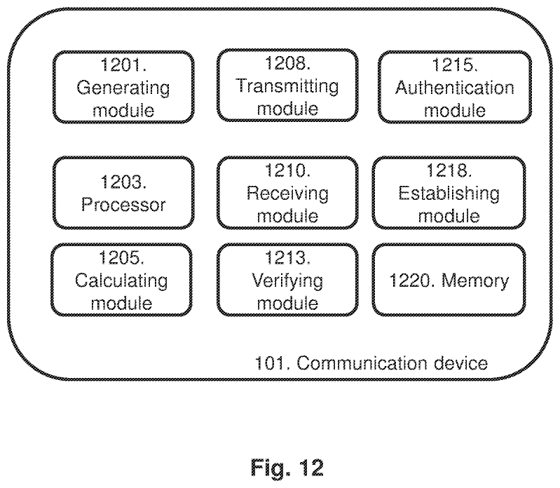

To perform the method steps shown in FIGS. 5-8 for for authentication of a TLS connection between the access GW node 103 and the communication device 101, the communication device 101 of a non-3GPP access may comprise an arrangement as shown in FIG. 12. The communication device 101 may be a UE 101a or a RG 101b.

The communication device 101 is configured to, e.g. by means of a generating module 1201, generate a 2^{nd} key derived during an authentication procedure of the communication device 101. The generating module 1201 may also be referred to as a generating unit, a generating means, a generating circuit, means for generating etc. The generating module 1201 may be a processor 1203 of the communication device 101 or comprised in the processor 1203 of the communication device 101.

The communication device 101 is configured to, e.g. by means of a calculating module 1205, calculate first authentication data based on a 1^{st}, key and the 2^{nd} key and for a TLS message to be transmitted. The 1^{st} key is associated with a TLS connection between an access GW node 103 and the communication device 101. The 2^{nd} key is based on at least one of an EMSK, a MSK and a master_secret key. The first authentication data may comprise a first Hash parameter or a first Auth parameter. The calculating module 1205 may also be referred to as a calculating unit, a calculating means, a calculating circuit, means for calculating etc. The calculating module 1205 may be the processor 1203 of the communication device 101 or comprised in the processor 1203 of the communication device 101.

The communication device 101 is configured to, e.g. by means of a transmitting module 1208, transmit a first TLS message comprising first authentication data to the access GW node 103. The transmitted first TLS message may be a transmitted first TLS finished message, or a transmitted first TLS heartbeat message, or a transmitted first TLS Data message. The transmitting module 1208 may also be referred to as a transmitting unit, a transmitting means, a transmitting circuit, means for transmitting, output unit etc. The transmitting module 1208 may be a transmitter, a transceiver etc. The transmitting module 1208 may be a wireless transmitter of the communication device 101 of a wireless or fixed communications system.

The communication device 101 is configured to, e.g. by means of a receiving module 1210, receive a second TLS message comprising third authentication data from the access GW node 103. The received second TLS message may be a received second TLS finish message or a received second TLS heartbeat message or a received second TLS data message. The third authentication data may comprise a third Hash parameter or a third Auth parameter. The receiving module 1210 may also be referred to as a receiving unit, a receiving means, a receiving circuit, means for receiving, input unit etc. The receiving module 1210 may be a receiver, a transceiver etc. The receiving module 1210 may be a wireless receiver of the communication device 101 of a wireless or fixed communications system.

The communication device 101 is configured to, e.g. by means of the calculating module 1205, calculate fourth authentication data based on the 1^{st} and 2^{nd} keys. The fourth authentication data may comprise a fourth Hash parameter or a fourth Auth parameter.

The communication device 101 is configured to, e.g. by means of a verifying module 1213, verify that the received third authentication data is substantially the same as the calculated fourth authentication data. The verifying module 1213 may also be referred to as a verifying unit, a verifying means, a verifying circuit, means for verifying etc. The verifying module 1213 may be the processor 1203 of the communication device 101 or comprised in the processor 1203 of the communication device 101.

The communication device 101 is configured to, e.g. by means of an authentication module 1215, authenticate the TLS connection between the access GW node 103 and the communication device 101 when the received third authentication data is successfully verified. The authentication module 1215 may also be referred to as an authentication unit, an authentication means, an authentication circuit, means for authentication etc. The authentication module 1215 may be the processor 1203 of the communication device 101 or comprised in the processor 1203 of the communication device 101.

The communication device 101 is configured to, e.g. by means of an establishing module 1218, establish the TLS connection with the access GW node 103. The establishing module 1218 may also be referred to as an establishing unit, an establishing means, an establishing circuit, means for establishing etc. The establishing module 1215 may be the processor 1203 of the communication device 101 or comprised in the processor 1203 of the communication device 101.

The communication device 101 is configured to, e.g. by means of the transmitting module 1208, transmit a registration request to the access node 103 via the TLS connection. The registration request comprises a NAS PDU, and/or an AS, PDU.

The communication device 101 may comprise a memory 1220. The memory 1220 comprises instructions executable by the processor 1203.

A second computer program may comprise instructions which, when executed on at least one processor, cause the at least one processor to carry out the method steps 1100-1108. A second carrier may comprise the second computer program, and the second carrier is one of an electronic signal, optical signal, radio signal or computer readable storage medium.

Summarized, the embodiments herein relate to TLS based methods to support secure signaling transport to 5G converged core through non-3GPP/fixed access. The TLS connection may be referred to as a named non-3GPP TLS tunnel (N3TT) which is established between the communication device 101 (UE 101a or RG 101b) and the access GW node 103 (e.g. N3IWF 1013a or AGF 103b) in the non-3GPP AN 106. The embodiments herein support secure TLS connection authentication for N3TT basing on credentials of 3GPP registration.

The embodiments herein are applicable to all non-3GPP access including fixed access. They are also applicable to an untrusted network environment but also to a trusted network where integrity protection is still considered.

The embodiments herein are not limited to the above described embodiments. Various alternatives, modifications and equivalents may be used. Therefore, the above embodiments should not be taken as limiting the scope of the embodiments, which is defined by the appended claims. A feature from one embodiment may be combined with one or more features of any other embodiment.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

It should also be emphasised that the steps of the methods defined in the appended claims may, without departing from the embodiments herein, be performed in another order than the order in which they appear in the claims.

1. A method performed by an access gateway, GW, node of a non-Third Generation Partnership Project, non-3GPP, access, for authentication of a Transport Layer Security, TLS, connection, between the access GW node and a communication device, the method comprising:
receiving, from a Core Network, CN, function, a second, 2^{nd}, key derived during an authentication procedure of the communication device;
receiving a first TLS message comprising first authentication data from the communication device;
calculating second authentication data based on a first, 1^{st}, key and the 2^{nd} key and for the received first TLS message, wherein the 1^{st} key is associated with the TLS connection;
calculating third authentication data based on the 1^{st} and 2^{nd} keys and for a second TLS message to be transmitted;
transmitting the second TLS message comprising the third authentication data to the communication device;
verifying that the received first authentication data is substantially the same as the calculated second authentication data; and
authenticating the TLS connection when the received first authentication data is successfully verified.

2. The method according to claim 1, further comprising:
establishing the TLS connection with the communication device.

3. The method according to claim 1, further comprising:
receiving a registration request from the communication device via the TLS connection, wherein the registration request comprises a Non-Access Stratum, NAS, Protocol Data Unit, PDU, and/or an Access Stratum, AS, PDU; and
transmitting the registration request comprising the NAS PDU to the CN function.

4. The method according to claim 1, wherein the 2^{nd} key is based on at least one of an Extended Master Session Key, EMSK, a Master Session Key, MSK, and a master_secret key.

5. The method according to claim 1, wherein the received first TLS message is a received first TLS finished message, or a received first TLS heartbeat message, or a received first TLS Data message.

6. The method according to claim 1, wherein the transmitted second TLS message is a transmitted second TLS finish message or a transmitted second TLS heartbeat message or a transmitted second TLS data message.

7. The method according to claim 1, wherein the first authentication data comprises a first Hash parameter or a first Auth parameter, wherein the second authentication data comprises a second Hash parameter or a second Auth parameter, and
wherein the third authentication data comprises a third Hash parameter or a third Auth parameter.

8. The method according to claim 1, wherein the access GW node is a Non-3GPP Interworking Function, N3IWF, an Access Gateway Function, AGF, or a Fixed Access Gateway Function, FGAF.

9. A method performed by a communication device of an non-Third Generation Partnership Project, non-3GPP, access, for authentication of a Transport Layer Security, TLS, connection, between an access gateway, GW, node and the communication device, the method comprising:
generating, a second, 2^{nd}, key derived during an authentication procedure of the communication device;
calculating first authentication data based on a first, 1^{st}, key and the 2^{nd} key and for a TLS message to be transmitted, wherein the 1^{st} key is associated with the TLS connection;
transmitting a first TLS message comprising first authentication data to the access GW node;
receiving a second TLS message comprising third authentication data from the access GW node;
calculating fourth authentication data based on the 1^{st} and 2^{nd} keys;
verifying that the received third authentication data is substantially the same as the calculated fourth authentication data; and
authenticating the TLS connection when the received third authentication data is successfully verified.

10. The method according to claim 9, further comprising:
establishing the TLS connection with the access GW node.

11. The method according to claim 9, further comprising:
transmitting a registration request to the access node via the TLS connection, wherein the registration request comprises a Non-Access Stratum, NAS, Protocol Data Unit, PDU, and/or an Access Stratum, AS, PDU.

12. The method according to claim 9, wherein the 2^{nd} key is based on at least one of an Extended Master Session Key, EMSK, a Master Session Key, MSK, and a master_secret key.

13. The method according to claim 9, wherein the transmitted first TLS message is a transmitted first TLS finished message, or a transmitted first TLS heartbeat message, or a transmitted first TLS Data message.

14. The method according to claim 9, wherein the received second TLS message is a received second TLS finish message or a received second TLS heartbeat message or a received second TLS data message.

15. The method according to claim 9, wherein the first authentication data comprises a first Hash parameter or a first Auth parameter, wherein the third authentication data comprises a third Hash parameter or a third Auth parameter, and
wherein the fourth authentication data comprises a fourth Hash parameter or a fourth Auth parameter.

16. The method according to claim 9, wherein the communication device is a User Equipment, UE or a Residential Gateway, RG.

17. A access gateway, GW, node of a non-Third Generation Partnership Project, non-3GPP, access, the access GW node being configured to:
receive, from a Core Network, CN, function, a second, 2^{nd}, key derived during an authentication procedure of a communication device;
receive a first TLS message comprising first authentication data from the communication device;
calculate second authentication data based on a first, 1^{st}, key and the 2^{nd} key and for the received first Transport Layer Security, TLS, message, wherein the 1^{st} key is associated with a TLS connection between the access GW node and the communication device;
calculate third authentication data based on the 1^{st} and 2^{nd} keys and for a second TLS message to be transmitted;
transmit the second TLS message comprising the third authentication data to the communication device;
verify that the received first authentication data is substantially the same as the calculated second authentication data; and to
authenticate the TLS connection between the access GW node and a communication device when the received first authentication data is successfully verified.

18. The access GW node according to claim 17 comprising processing circuitry; and memory coupled with processing circuitry, wherein the memory includes instructions that when executed by the processing circuitry causes the access GW node to perform further operations comprising one or more of:
establish the TLS connection with the communication device;
receive a registration request from the communication device via the TLS connection, wherein the registration request comprises a Non-Access Stratum, NAS, Protocol Data Unit, PDU, and/or an Access Stratum, AS, PDU; and to
transmit the registration request comprising the NAS PDU to the CN function.

19.-24. (canceled)

25. A communication device of a non-Third Generation Partnership Project, non-3GPP, access, the communication device 4044 being configured to:
generate a second, 2^{nd}, key derived during an authentication procedure of the communication device;
calculate first authentication data based on a first, 1^{st}, key and the 2^{nd} key and for a Transport Layer Security, TLS, message to be transmitted, wherein the 1^{st} key is associated with a TLS connection between an access gateway, GW, node and the communication device;
transmit a first TLS message comprising first authentication data to the access GW node;
receive a second TLS message comprising third authentication data from the access GW node;
calculate fourth authentication data based on the 1^{st} and 2^{nd} keys;
verify that the received third authentication data is substantially the same as the calculated fourth authentication data; and to
authenticate the TLS connection between the access GW node and the communication device when the received third authentication data is successfully verified.

26. The communication device according to claim 25 comprising processing circuitry; and memory coupled with processing circuitry, wherein the memory includes instructions that when executed by the processing circuitry causes the communication device to perform further operations comprising one or more of:
establish the TLS connection with the access GW node; and
transmit a registration request to the access node via the TLS connection, wherein the registration request comprises a Non-Access Stratum, NAS, Protocol Data Unit, PDU, and/or an Access Stratum, AS, PDU.

27.-36. (canceled)
